(19) United States
(12) Patent Application Publication
(10) Pub. No.: US 2026/0149542 A1
(43) Pub. Date: May 28, 2026

(54) METHOD FOR CONTROL SIGNALING FOR SRS INTERFERENCE RANDOMIZATION

(71) Applicant: Google LLC, Mountain View, CA (US)

(72) Inventor: Yushu Zhang, Beijing (CN)

(21) Appl. No.: 19/121,277

(22) PCT Filed: Nov. 4, 2022
(86) PCT No.: PCT/CN2022/130006

§ 371 Date: Apr. 15, 2025

(51) Int. Cl. H04L 5/00

(52) U.S. Cl. CPC H04L 5/0051; H04L 5/006

(57) ABSTRACT

Devices, apparatus, and methods, including computer programs encoded on storage media, alter at least one of comb offset, cyclic shift and TD-OCC to randomize SRS interference at unintended receivers. A user equipment (UE, 102) receives (322), from a network entity, an SRS-randomization configuration specifying parameters and/or a hopping pattern enable applying at least one of: a comb offset hopping, a cyclic shift hopping, or a time-domain orthogonal cover code (TD-OCC) hopping. The UE generates (326) an SRS using one or more of the comb offset hopping, the cyclic shift hopping and the TD-OCC hopping based on the parameters and/or the hopping pattern. The UE transmits (328), to the network entity, the SRS.

### TECHNICAL FIELD

The present disclosure relates generally to wireless communication, and more particularly, to methods for control signaling for sounding reference signal (SRS) interference randomization.

### BACKGROUND

The Third Generation Partnership Project (3GPP) specifies a radio interface referred to as fifth generation (5G) new radio (NR) (5G NR). An architecture for a 5G NR wireless communication system can include a 5G core (5GC) network, a 5G radio access network (5G-RAN), a user equipment (UE), etc. The 5G NR architecture might provide increased data rates, decreased latency, and/or increased capacity compared to other types of wireless communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband have been useful to continue the progression of such wireless communication technologies. With increasing usage new challenges occur, such as interference caused by sounding reference signals (SRSs) emitted by a user equipment (UE), at an unintended receiver.

### SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

Interference randomization is performed to reduce an interference caused by sounding reference signals (SRSs) emitted by a user equipment (UE), at an unintended receiver of a neighboring network entity and/or another UE. The interference randomization alters comb offset, cyclic shift and/or time-domain orthogonal cover code (TD-OCC) when generating at least one SRS so that the SRSs to exhibit noise-like behavior at the unintended receiver. To randomize interference at the unintended receiver, the UE generates the SRS using comb offset hopping, cyclic shift hopping, and/or TD-OCC hopping without regard to which of these SRS-randomization techniques reduces the interference at the neighboring network entities and other UEs most significantly.

The network entity provides an SRS-randomization configuration to the UE for SRS randomization. The SRS-randomization configuration conveys parameters and/or a hopping pattern enabling the UE to apply one or more comb offset hopping, cyclic shift hopping, and/or TD-OCC hopping. In response to receiving the SRS-randomization configuration, the UE generates and transmits the SRSs using the parameters and/or hopping pattern from the SRS-randomization configuration thereby randomizing the comb offset, the cyclic shifts and/or the TD-OCCs.

When generating an SRS using the comb offset hopping, a comb offset parameter for an antenna port is determined. Similarly, when generating the SRS using the cyclic shift hopping, a cyclic shift parameter for the antenna port is calculated. A TD-OCC is determined and applied to symbols when generating the SRS using the TD-OCC hopping. By using the determined comb offset, cyclic shift, or TD-OCC, the interference randomization alters the comb offset, cyclic shift and/or TD-OCC that would be otherwise applied.

According to some aspects, the UE receives, from a network entity, an SRS-randomization configuration comprising parameters and/or a hopping pattern enabling at least one of: a comb offset hopping, a cyclic shift hopping, or a TD-OCC hopping. The UE generates an SRS using one or more of the comb offset hopping, the cyclic shift hopping and the TD-OCC hopping based on the parameters and/or the hopping pattern. The UE transmits, to the network entity, the SRS.

According to some aspects, the network entity transmits, to the UE, an SRS-randomization configuration including parameters and/or a hopping pattern to apply at least one of: a comb offset hopping, a cyclic shift hopping, or a TD-OCC hopping. The network entity receives, from the UE, the SRS generated using one or more of the comb offset hopping, the cyclic shift hopping and the TD-OCC hopping based on the parameters and/or the hopping pattern.

Accordingly, the UE and/or the network entity performing the interference randomization can reduce interference caused by SRSs emitted by the UE at an unintended receiver of a neighboring network entity and/or another UE, which interference degrades overall system performance.

Another example includes a base station (BS) or UE with hardware configured to implement the above-described methods.

### BRIEF DESCRIPTION OF THE DRAWINGS

FIG. 1 is a diagram of a wireless communications system that includes a plurality of UEs and network entities in communication over one or more cells.

FIG. 2 is a diagram illustrating an example of symbol and subcarrier locations of SRS dedicated resources, according to some embodiments.

FIGS. 3A-3B are signaling diagrams for an SRS signal interference randomization using a comb offset hopping, according to some embodiments.

FIGS. 4A-4B are signaling diagrams for an SRS signal interference randomization using a cyclic shift hopping, according to some embodiments.

FIGS. 5A-SB are signaling diagrams for an SRS signal interference randomization using a time-domain orthogonal cover code (TD-OCC) hopping, according to some embodiments.

FIG. 6 is a signaling diagram for an SRS signal interference randomization using any one of comb offset hopping, a cyclic shift hopping, or a TD-OCC hopping, according to some embodiments.

FIG. 7 is a flowchart of a method of interference randomization performed by a UE, according to some embodiments.

FIG. 8 is a flowchart of a method of interference randomization performed by a network entity, according to some embodiments.

FIG. 9 is a block diagram illustrating a hardware implementation for an example UE apparatus.

FIG. 10 is a diagram illustrating a hardware implementation for one or more example network entities.

### DETAILED DESCRIPTION

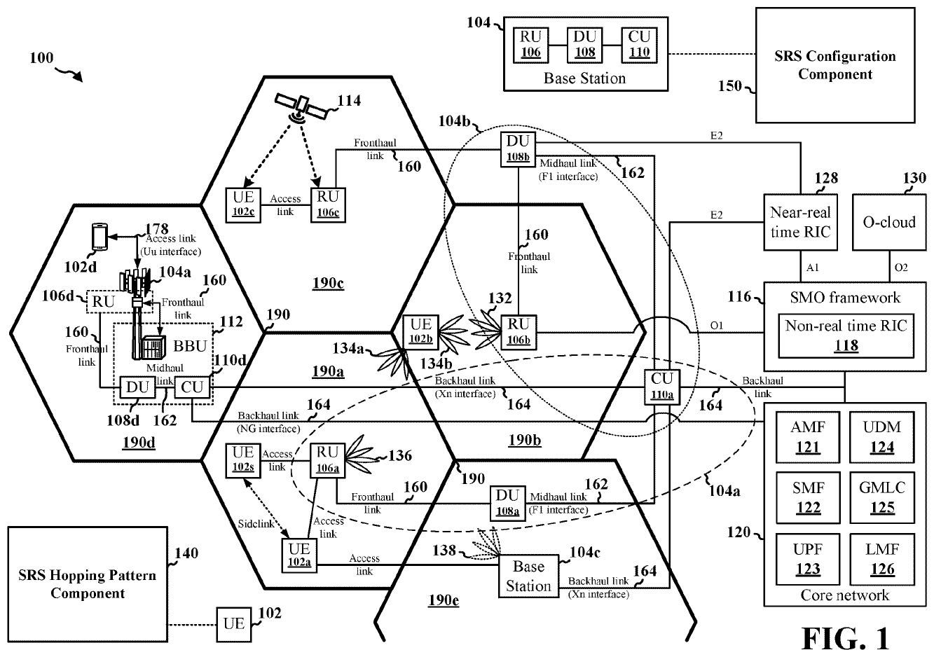

FIG. 1 illustrates a diagram 100 of a wireless communications system associated with a plurality of cells 190. The wireless communications system includes user equipments (UEs) 102 and base stations 104, where some base stations 104c include an aggregated base station architecture and other base stations 104a-104b include a disaggregated base station architecture. The UEs 102 may communicate with the base stations 104c via one or more radio frequency (RF) access links 178. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU). A base station 104 and/or a unit of the base station 104, such as the RU 106, the DU 108, or the CU 110, may be referred to as a transmission reception point (TRP).

Operations of the base stations 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN) which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the CU 110a communicates with the DUs 108a-108b via respective midhaul links 162 based on F1 interfaces. The DUs 108a-108b may respectively communicate with the RU 106a and the RUs 106b-106c via respective fronthaul links 160. The RUs 106a-106c may communicate with respective UEs 102a-102c and 102s via one or more radio frequency (RF) access links 178 based on a Uu interface. In examples, multiple RUs 106 and/or base stations 104 may simultaneously serve the UEs 102, such as the UE 102a of the cell 190a that the access links 178 for the RU 106a of the cell 190a and the base station 104c of the cell 190e simultaneously serve.

One or more CUs 110, such as the CU 110a or the CU 110d, may communicate directly with a core network 120 via a backhaul link 164. For example, the CU 110d communicates with the core network 120 over a backhaul link 164 based on a next generation (NG) interface. The one or more CUs 110 may also communicate indirectly with the core network 120 through one or more disaggregated base station units, such as a near-real time RAN intelligent controller (RIC) 128 via an E2 link and a service management and orchestration (SMO) framework 116, which may be associated with a non-real time RIC 118. The near-real time RIC 128 might communicate with the SMO framework 116 and/or the non-real time RIC 118 via an A1 link. The SMO framework 116 and/or the non-real time RIC 118 might also communicate with an open cloud (O-cloud) 130 via an O2 link. The one or more CUs 110 may further communicate with each other over a backhaul link 164 based on an Xn interface. For example, the CU 110d of the base station 104c communicates with the CU 110a of the base station 104b over the backhaul link 164 based on the Xn interface. Similarly, the base station 104c of the cell 190e may communicate with the CU 110a of the base station 104b over a backhaul link 164 based on the Xn interface.

The RUs 106, the DUs 108, and the CUs 110, as well as the near-real time RIC 128, the non-real time RIC 118, and/or the SMO framework 116, may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as for the fronthaul link 160 between the RU 106d and the baseband unit (BBU) 112 of the cell 190d or, more specifically, the fronthaul link 160 between the RU 106d and DU 108d. The BBU 112 includes the DU 108d and a CU 110d, which may also have a wired interface configured between the DU 108d and the CU 110d to transmit or receive the information/signals between the DU 108d and the CU 110d based on a midhaul link 162. In further examples, a wireless interface, which may include a receiver, a transmitter, or a transceiver (such as an RF transceiver), can be configured to transmit or receive the information/signals via the wireless transmission medium, such as for information communicated between the RU 106a of the cell 190a and the base station 104c of the cell 190e via cross-cell communication beams of the RU 106a and the base station 104c.

One or more higher layer control functions, such as function related to radio resource control (RRC), packet data convergence protocol (PDCP), service data adaptation protocol (SDAP), and the like, may be hosted at the CU 110. Each control function may be associated with an interface for communicating signals based on one or more other control functions hosted at the CU 110. User plane functionality such as central unit-user plane (CU-UP) functionality, control plane functionality such as central unit-control plane (CU-CP) functionality, or a combination thereof may be implemented based on the CU 110. For example, the CU 110 can include a logical split between one or more CU-UP procedures and/or one or more CU-CP procedures. The CU-UP functionality may be based on bidirectional communication with the CU-CP functionality via an interface, such as an E1 interface (not shown), when implemented in an O-RAN configuration.

The CU 110 may communicate with the DU 108 for network control and signaling. The DU 108 is a logical unit of the base station 104 configured to perform one or more base station functionalities. For example, the DU 108 can control the operations of one or more RUs 106. One or more of a radio link control (RLC) layer, a medium access control (MAC) layer, or one or more higher physical (PHY) layers, such as forward error correction (FEC) modules for encoding/decoding, scrambling, modulation/demodulation, or the like can be hosted at the DU 108. The DU 108 may host such functionalities based on a functional split of the DU 108. The DU 108 may similarly host one or more lower PHY layers, where each lower layer or module may be implemented based on an interface for communications with other layers and modules hosted at the DU 108, or based on control functions hosted at the CU 110.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RUs 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or cross-cell communication beams. For example, the UE 102b of the cell 190b may communicate with the RU 106a of the cell 190a via a third set of communication beams 134a of the UE 102b and an RU beam set 136 of the RU 106a. Both real-time and non-real-time features of control plane and user plane communications of the RUs 106 can be controlled by associated DUs 108. Accordingly, the DUs 108 and the CUs 110 can be utilized in a cloud-based RAN architecture, such as a vRAN architecture, whereas the SMO framework 116 can be utilized to support non-virtualized and virtualized RAN network elements. For non-virtualized network elements, the SMO framework 116 may support deployment of dedicated physical resources for RAN coverage, where the dedicated physical resources may be managed through an operations and maintenance interface, such as an O1 interface. For virtualized network elements, the SMO Framework 116 may interact with a cloud computing platform, such as the O-cloud 130 via the O2 link (e.g., cloud computing platform interface), to manage the network elements. Virtualized network elements can include, but are not limited to, RUs 106, DUs 108, CUs 110, near-real time RICs 128, etc.

The SMO framework 116 may be configured to utilize an O1 link to communicate directly with one or more RUs 106. The non-real time RIC 118 of the SMO framework 116 may also be configured to support functionalities of the SMO framework 116. For example, the non-real time RIC 118 implements logical functionality that enables control of non-real time RAN features and resources, features/applications of the near-real time RIC 128, and/or artificial intelligence/machine learning (AI/ML) procedures. The non-real time RIC 118 may communicate with (or be coupled to) the near-real time RIC 128, such as through the A1 interface. The near-real time RIC 128 may implement logical functionality that enables control of near-real time RAN features and resources based on data collection and interactions over an E2 interface, such as the E2 interfaces between the near-real time RIC 128 and the CU 110a and the DU 108b.

The non-real time RIC 118 may receive parameters or other information from external servers to generate AI/ML models for deployment in the near-real time RIC 128. For example, the non-real time RIC 118 receives the parameters or other information from the O-cloud 130 via the O2 link for deployment of the AI/ML models to the real-time RIC 128 via the A1 link. The near-real time RIC 128 may utilize the parameters and/or other information received from the non-real time RIC 118 or the SMO framework 116 via the A1 link to perform near-real time functionalities. The near-real time RIC 128 and the non-real time RIC 118 may be configured to adjust a performance of the RAN. For example, the non-real time RIC 118 monitors patterns and long-term trends to increase the performance of the RAN. The non-real time RIC 118 may also deploy AI/ML models for implementing corrective actions through the SMO framework 116, such as initiating a reconfiguration of the O1 link or indicating management procedures for the A1 link.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to the core network 120. That is, the base stations 104 might relay communications between the UEs 102 and the core network 120. The base stations 104 may be associated with macrocells for high-power cellular base stations and/or small cells for low-power cellular base stations. For example, the cell 190e corresponds to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104c of cell 190d to transmit a downlink/forward link communication to the UE 102d or receive an uplink/reverse link communication from the UE 102d based on the Uu interface associated with the access link 178 between the UE 102d and the base station 104c/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 24.25 GHz-71.0 GHz, which includes FR2-1 (24.25 GHz-52.6 GHz) and FR2-2 (52.6 GHz-71.0 GHz). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHz, FR4, which ranges from 71.0 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of beams 132 to the UE 102b in one or more transmit directions of the RU 106b. The UE 102b may receive the downlink beamformed signal based on a second set of beams 134b from the RU 106b in one or more receive directions of the UE 102b. In a further example, the UE 102b may also transmit an uplink beamformed signal to the RU 106b based on the second set of beams 134b in one or more transmit directions of the UE 102b. The RU 106b may receive the uplink beamformed signal from the UE 102b in one or more receive directions of the RU 106b. The UE 102b may perform beam training to determine the best receive and transmit directions for the beam formed signals. The transmit and receive directions for the UEs 102 and the base stations 104/RUs 106 might or might not be the same. In further examples, beamformed signals may be communicated between a first base station 104c and a second base station 104b. For instance, the RU 106a of cell 190a may transmit a beamformed signal based on the RU beam set 136 to the base station 104c of cell 190e in one or more transmit directions of the RU 106a. The base station 104c of the cell 190e may receive the beamformed signal from the RU 106a based on a base station beam set 138 in one or more receive directions of the base station 104c. Similarly, the base station 104c of the cell 190e may transmit a beamformed signal to the RU 106a based on the base station beam set 138 in one or more transmit directions of the base station 104c. The RU 106a may receive the beamformed signal from the base station 104c of the cell 190e based on the RU beam set 136 in one or more receive directions of the RU 106a.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station with an RU 106 and a BBU that includes a DU 108 and a CU 110, or as a disaggregated base station 104b including one or more of the RU 106, the DU 108, and/or the CU 110. A set of aggregated or disaggregated base stations 104a-104b may be referred to as a next generation-radio access network (NG-RAN). In some examples, the UE 102b operates in dual connectivity (DC) with the base station 104a and the base station 104b. In such cases, the base station 104a can be a master node and the base station 104b can be a secondary node. In other examples, the UE 102b operates in DC with the DU 108a and the DU 108b. In such cases, the DU 108a can be the master node and the DU 108b can be the secondary node.

The core network 120 may include an Access and Mobility Management Function (AMF) 121, a Session Management Function (SMF) 122, a User Plane Function (UPF) 123, a Unified Data Management (UDM) 124, a Gateway Mobile Location Center (GMLC) 125, and/or a Location Management Function (LMF) 126. The core network 120 may also include one or more location servers, which may include the GMLC 125 and the LMF 126, as well as other functional entities. For example, the one or more location servers include one or more location/positioning servers, which may include the GMLC 125 and the LMF 126 in addition to one or more of a position determination entity (PDE), a serving mobile location center (SMLC), a mobile positioning center (MPC), or the like.

The AMF 121 is the control node that processes the signaling between the UEs 102 and the core network 120. The AMF 121 supports registration management, connection management, mobility management, and other functions. The SMF 122 supports session management and other functions. The UPF 123 supports packet routing, packet forwarding, and other functions. The UDM 124 supports the generation of authentication and key agreement (AKA) credentials, user identification handling, access authorization, and subscription management. The GMLC 125 provides an interface for clients/applications (e.g., emergency services) for accessing UE positioning information. The LMF 126 receives measurements and assistance information from the NG-RAN and the UEs 102 via the AMF 121 to compute the position of the UEs 102. The NG-RAN may utilize one or more positioning methods in order to determine the position of the UEs 102. Positioning the UEs 102 may involve signal measurements, a position estimate, and an optional velocity computation based on the measurements. The signal measurements may be made by the UEs 102 and/or the serving base stations 104/RUs 106.

Communicated signals may also be based on one or more of a satellite positioning system (SPS) 114, such as signals measured for positioning. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

The UEs 102 may be configured as a cellular phone, a smart phone, a session initiation protocol (SIP) phone, a laptop, a personal digital assistant (PDA), a satellite radio, a GPS, a multimedia device, a video device, a digital audio player (e.g., moving picture experts group (MPEG) audio layer-3 (MP3) player), a camera, a game console, a tablet, a smart device, a wearable device, a vehicle, an utility meter, a gas pump, appliances, a healthcare device, a sensor/actuator, a display, or any other device of similar functionality. Some of the UEs 102 may be referred to as Internet of Things (IoT) devices, such as parking meters, gas pumps, appliances, vehicles, healthcare equipment, etc. The UE 102 may also be referred to as a station (STA), a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a mobile client, a client, or other similar terminology. The term UE may also apply to a roadside unit (RSU), which may communicate with other RSU UEs, non-RSU UEs, a base station 104, and/or an entity at a base station 104, such as an RU 106.

Still referring to FIG. 1, in certain aspects, the UE 102 may include an SRS hopping pattern component 140 configured to receive, from a network entity, an SRS-randomization configuration comprising parameters and/or a hopping pattern to apply at least one of: a comb offset hopping, a cyclic shift hopping, or a time-domain orthogonal cover code (TD-OCC) hopping. The UE generates an SRS using one or more of the comb offset hopping, the cyclic shift hopping and the TD-OCC hopping based on the parameters and/or the hopping pattern. The UE transmits, to the network entity, the SRS.

In certain aspects, the base station 104 or a network entity of the base station 104 may include an SRS configuration component 150 configured to transmit, to a user equipment (UE), an SRS-randomization configuration comprising parameters and/or a hopping pattern to apply at least one of: a comb offset hopping, a cyclic shift hopping, or a TD-OCC hopping. The SRS configuration component 150 is configured to receive, from the UE, the SRS generated using one or more of the comb offset hopping, the cyclic shift hopping and the TD-OCC hopping based on the parameters and/or the hopping pattern.

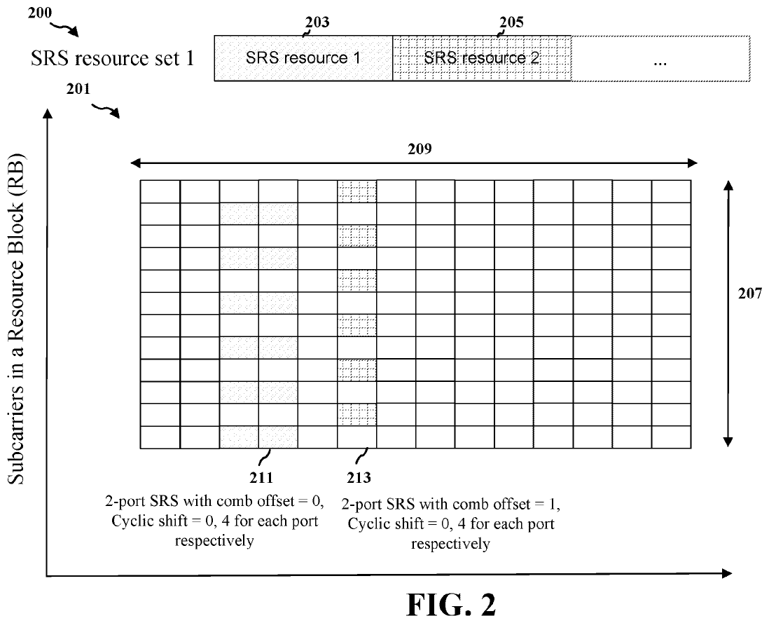

Accordingly, FIG. 1 describes a wireless communication system that may use embodiments, such as the ones illustrated in FIGS. 2-10. Further, although the following description may be focused on 5G NR, the concepts described herein may be applicable to other similar areas, such as 5G-Advanced and future versions, LTE, LTE-advanced (LTE-A), and other wireless technologies, such as 6G.

FIG. 2 is a diagram illustrating an example of symbol and subcarrier locations for SRS resource allocation. In SRS resource allocation, an SRS resource set1 200 might include SRS resource1 203, SRS resource2 205, etc. Although SRS resource allocation shows the SRS resource set1 200, SRS resource allocation might include more than one SRS resource set (e.g., SRS resource set1 200). Although the SRS resource set 200 shows SRS resource1 203, SRS resource2 205, the SRS resource set 200 might include more than the illustrated SRS resource. In this example, SRS resource1 203 and SRS resource2 include a resource block (RB) 201 consists of 12 subcarriers 207 and this example shows an RB with 14 symbols 209. The UE 102 might transmit an SRS on SRS resource1 203. A network entity 104 might transmit a configuration for SRS resource1 203. For example, the configuration might indicate a pattern 211 with comb offset=0, a cyclic shift=0, 4. The UE 102 transmits the SRS in two symbols on every other subcarriers. In another example, the network entity 104 might transmit a configuration for SRS resource2 205. the configuration might indicate a pattern 213 with comb offset=1, a cyclic shift=0, 4. The UE 102 transmits the SRS in one symbol on every other subcarrier.

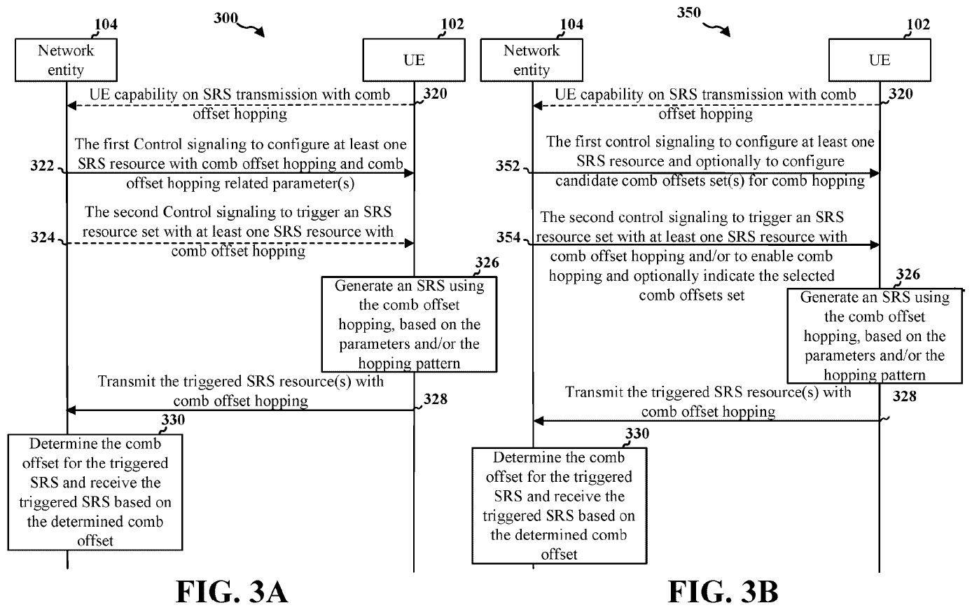

FIG. 2 illustrates an example of SRS symbol locations for an SRS transmission, whereas FIGS. 3A-3B illustrate example procedures for an SRS signal interference randomization using a comb offset hopping.

FIGS. 3A-3B are signaling diagrams 300-350 for an SRS signal interference randomization. In particular, the signaling diagram 300 illustrates an example of an SRS signal interference randomization using a comb offset hopping, whereas the signaling diagram 350 illustrates another example of an SRS signal interference randomization using a comb offset hopping. Example procedures 300-350 can be implemented by the UE 102 communicating with the network entity 104 depicted in FIG. 1.

Referring to FIG. 3A, initially, a UE 102 might transmit 320, to a network entity 104, a UE capability report. For example, the UE 102 transmits 320, to the network entity 104, the UE capability report regarding an SRS transmission with a comb offset hopping. The UE capability report includes an indication that indicates a UE's ability to apply the comb offset hopping. The UE capability report further includes at least one of an indication of a supported time domain behavior for the SRS with comb hopping (e.g., periodic/semi-persistent/aperiodic; supported usage of SRS with comb hopping).

The UE capability report indicates an SRS type for which the UE is able to apply at least one of the comb offset hopping, the cyclic shift hopping, and the TD-OCC hopping.

The UE capability report indicates at least one of a first maximum number of comb offsets associated with the comb offset hopping, a second maximum number of cyclic shifts associated with the cyclic shift hopping, or a third maximum number of TD-OCCs associated with the TD-OCC hopping.

In some examples, the network entity 104 might receive, from a core network (e.g., Access and Mobility Management Function (AMF)), the UE capability report. In some other examples, the network entity might receive, from another base station (e.g., gNB or eNB), the UE capability report. Based on the UE capability report, the network entity 104 might configure at least one SRS resource in one SRS resource set with a comb hopping and comb hopping related parameters. In some other examples, the network entity 104 might transmit, to the UE, an RRC message (e.g., RRCReconfiguration message) to configure a periodicity and a slot offset for a periodic SRS. For a semi-persistent SRS, the network entity 104 might transmit, to the UE 102, a MAC-CE to trigger a transmission. For an aperiodic SRS, the network entity 104 might transmit, to the UE 102, a DCI to trigger the transmission. For each transmission occasion for a triggered SRS resource with comb offset hopping, the UE 102 determines a comb offset for each transmission occasion. Then, the UE 102 transmits the SRS based on the determined comb offset. The network entity 104 determines the comb offset for the triggered SRS resource and receives the SRS based on the determined comb offset.

The network entity 104 transmits 322, to the UE 102, an SRS-randomization configuration including parameters and/or a hopping pattern to apply a comb offset hopping.

In some examples, the network entity 104 might transmit 322, to the UE 102, an RRC parameter to enable or disable the comb offset hopping for an SRS resource or for an SRS resource set. In some examples, the network entity 104 might enable the comb offset hopping for all types of SRS, e.g., periodic, semi-persistent, aperiodic. In some other examples, the network entity 104 might enable the comb offset hopping for some types of SRS (e.g. periodic, semi-persistent), an SRS with a potential usage (e.g., an SRS for a codebook (CB), a non-codebook (NCB), a beam management (BM), and an antenna switching (AS)). The network entity 104 can configure a usage of an SRS resource set by a RRC parameter usage.

In one example, the network entity 104 might transmit an RRC parameter (e.g., combOffsetHopping) in an SRS resource as an indication to enable/disable the comb offset hopping for the SRS resource. The comb offset hopping is enabled if the RRC parameter is present. Otherwise, the comb offset hopping is disabled.

In another example, the network entity 104 might transmit an RRC parameter combOffsetHopping in an SRS resource set as an indication to enable/disable the comb offset hopping for the SRS resources within the SRS resource set. If the RRC parameter is present, the comb offset hopping is enabled; otherwise, the comb offset hopping is disabled.

The SRS for the CB is used for an uplink channel state information (CSI) measurement for uplink CB-based transmission. The UE 102 transmits the SRS for the CB from one or more one antenna ports. The network entity 104 measures the uplink channel based on the SRS for the CB and selects a precoder from a predefined CB. Usually, the selected precoder might be one that can produce the strongest precoded channel energy based on the estimated channel. Then, the network entity 104 might indicate, to UE 102, the precoder via a downlink control information (DCI) field precoding information and number of layers. The DCI also indicates a transmit precoder matrix indicator (TPMI) and a transmit rank indicator (TRI). Then, the UE 102 can identify the precoder for a physical uplink shared channel (PUSCH) transmission based on the predefined precoder indicated by the TPMI and TRI.

The SRS for the NCB is used for uplink CSI measurement for uplink NCB-based transmission. For an SRS resource set for the NCB, the network entity 104 can configure an associated CSI reference signal (CSI-RS) by RRC signaling. The UE can estimate a downlink channel based on the associated CSI-RS and use the estimated downlink channel to derive the uplink precoder for the SRS with the assumption of uplink and downlink channel reciprocity.

The SRS for a BM is used for an uplink beam measurement and selection. The UE 102 can apply different beams to different SRS resources for the BM. The network entity 104 performs a measurement of the SRS resources. Then, based on the measurement of the SRS resources for BM, the network entity 104 performs the uplink beam selection by indicating an SRS resource indicator (SRI) for an uplink channel, e.g., PUSCH, PUCCH or another SRS, to the UE 102. The UE 102 transmits a corresponding uplink channel based on the same beam that is applied to the SRS indicated by the SRI.

The SRS for the AS is used for a downlink CSI measurement based on an uplink and s downlink channel reciprocity. The UE 102 can transmit a set of SRS resources for the AS with different antenna port(s). Then, by receiving the SRS resources, the network entity 104 can estimate the uplink channel to derive the downlink channel and determine the precoder for a downlink transmission. In one example, for a UE 102 with transmission antenna port, X (e.g., X=2), and receiving antenna ports, Y (e.g., Y=4), the network entity 104 can configure an SRS resource set with ceil(Y/X) that equals to 2 SRS resources, where each of the SRS resources are transmitted from X antenna ports.

The network entity 104 might transmit 324 control signaling that triggers the SRS using the one or more of the comb offset hopping. The control signaling indicates resources for the transmitting of the SRSs generated using the one or more of the comb offset hopping, the cyclic shift hopping and the TD-OCC hopping based on the parameters and/or the hopping pattern. In some examples, the control signaling may be a single control signaling (e.g., RRC signaling). The receiving of the control signaling can include receiving a radio resource control (RRC) signaling that indicates the resources for the transmitting of the SRSs. In some other examples, the control signaling may be two separate control signaling (e.g., a downlink control information (DCI) or a medium access-control element (MAC-CE)). The receiving of the control signaling can include receiving the medium access-control element (MAC-CE) or the downlink control information (DCI) that triggers the generating of the SRS.

Then, the UE 102 generates 326 an SRS using one or more of the comb offset hopping based on the parameters and/or the hopping pattern. In this manner, the UE 102 determines the comb offset for the triggered SRS resource with the comb offset hopping.

In some examples, the UE 102 determines a comb offset associated with the comb offset hopping for an SRS port corresponding to a symbol based on at least one of a symbol index, a slot index, a port index, a cell identifier (ID), or a virtual cell ID (e.g., sequenceId). The UE 102 might also determine the comb offset for the SRS port in a configured/scheduled symbol based on a subframe or a frame index configured via an RRC signaling.

In one example, the UE transmit the SRS at the resource element in resource element (k, l) at antenna port pᵢ for

$${α}_{k , l}^{( {p}_{i} )}$$

as follows. Other variables not discussed in the following paragraphs are defined in 3GPP specification 38.211:

$${a}_{{K}_{TC} {k}^{′} + {k}_{0}^{( {p}_{i} )} , {l}^{′} + {l}_{0}}^{( {p}_{i} )} = \{ \begin{matrix}\frac{1}{\sqrt{{N}_{ap}}} β {r}^{( {p}_{i} )} ( n , {l}^{′} ) , {k}^{′} = 0 , 1 , … {M}_{sc , b}^{SRS} - 1 , {l}^{′} = 0 , 1 , … , {N}_{symb}^{SRS} - 1 \\ 0 , otherwise\end{matrix}$$

### Where

$${k}_{0}^{( {p}_{i} )}$$

is calculated as follows:

$$\begin{matrix}{k}_{0}^{( {p}_{i} )} = {\overline{k}}_{0}^{( {p}_{i} )} + {n}_{offset}^{FH} + {n}_{offset}^{RPFS} \\ {\overline{k}}_{0}^{( P i )} = {n}_{shift} {N}_{s c}^{R B} + ( {k}_{TC}^{( {p}_{\dot{1}} )} + {k}_{offset}^{{l}^{′}} ) mod {K}_{TC}\end{matrix}$$

### Where

$${k}_{TC}^{( {p}_{i} )}$$

is the comb offset for antenna port pᵢ, which is calculated as follows:

$${k}_{TC}^{( {p}_{i} )} = \{ \begin{matrix}( {\overline{k}}_{TC} + \frac{{k}_{TC}}{2} + hash ( {l}^{′} , {p}_{i} ) ) mod {K}_{TC} , \\ if {N}_{ap}^{SRS} = 4 , {p}_{i} ∈ \{ 1001 , 1003 \} , {n}_{SRS}^{cs , max} = 6 \\ ( {\overline{k}}_{TC} + \frac{{k}_{TC}}{2} + hash ( {l}^{′} , {p}_{i} ) ) mod {K}_{TC} , if {N}_{ap}^{SRS} = 4 , \\ {p}_{i} ∈ \{ 1001 , 1003 \} , {n}_{SRS}^{cs} ∈ \{ \frac{{n}_{SRS}^{cs , max}}{2} , … {n}_{SRS}^{cs , max} - 1 \} \\ ( {\overline{k}}_{TC} + hash ( {l}^{′} , i ) ) mod {K}_{TC} , otherwise\end{matrix}$$

Alternatively,

$${k}_{TC}^{( {p}_{i} )}$$

is calculated as follows:

$${k}_{TC}^{( {p}_{i} )} = \{ \begin{matrix}( {\overline{k}}_{TC} + \frac{{k}_{TC}}{2} + hash ( {l}^{′} , {n}_{ID} , {p}_{i} ) ) mod {K}_{TC} , \\ if {N}_{ap}^{SRS} = 4 , {p}_{i} ∈ \{ 1001 , 1003 \} , {n}_{SRS}^{cs , max} = 6 \\ ( {\overline{k}}_{TC} + \frac{{k}_{TC}}{2} + hash ( {l}^{′} , {n}_{ID} , {p}_{i} ) ) mod {K}_{TC} , if {N}_{ap}^{SRS} = 4 , \\ {p}_{i} ∈ \{ 1001 , 1003 \} , {n}_{SRS}^{cs} ∈ \{ \frac{{n}_{SRS}^{cs , max}}{2} , … {n}_{SRS}^{cs , max} - 1 \} \\ ( {\overline{k}}_{TC} + hash ( {l}^{′} , {n}_{ID} , {p}_{i} ) ) mod {K}_{TC} , otherwise\end{matrix}$$

Alternatively,

$${k}_{TC}^{( {p}_{i} )}$$

is calculated as follows:

$${k}_{TC}^{( {p}_{i} )} = \{ \begin{matrix}( {\overline{k}}_{TC} + \frac{{k}_{TC}}{2} + hash ( {l}^{′} , {n}_{s} , {p}_{i} ) ) mod {K}_{TC} , \\ if {N}_{ap}^{SRS} = 4 , {p}_{i} ∈ \{ 1001 , 1003 \} , {n}_{SRS}^{cs , max} = 6 \\ ( {\overline{k}}_{TC} + \frac{{k}_{TC}}{2} + hash ( {l}^{′} , {n}_{s} , {p}_{i} ) ) mod {K}_{TC} , if {N}_{ap}^{SRS} = 4 , \\ {p}_{i} ∈ \{ 1001 , 1003 \} , {n}_{SRS}^{cs} ∈ \{ \frac{{n}_{SRS}^{cs , max}}{2} , … {n}_{SRS}^{cs , max} - 1 \} \\ ( {\overline{k}}_{TC} + hash ( {l}^{′} , {n}_{s} , {p}_{i} ) ) mod {K}_{TC} , otherwise\end{matrix}$$

Alternatively,

$${k}_{TC}^{( {p}_{i} )}$$

is calculated as follows:

$${k}_{TC}^{( {p}_{i} )} = \{ \begin{matrix}( {\overline{k}}_{TC} + \frac{{K}_{TC}}{2} + hash ( {l}^{′} , {n}_{s} , {n}_{ID} , {p}_{i} ) ) mod {K}_{TC} , if {N}_{ap}^{SRS} = 4 , {p}_{i} ∈ \{ 1001 , 1003 \} , {n}_{SRS}^{cs , max} = 6 \\ ( {\overline{k}}_{TC} + \frac{{K}_{TC}}{2} + hash ( {l}^{′} , {n}_{s} , {n}_{ID} , {p}_{i} ) ) mod {K}_{TC} , if {N}_{ap}^{SRS} = 4 , {p}_{i} ∈ \{ 1001 , 1003 \} , {n}_{SRS}^{cs} ∈ \{ \frac{{n}_{SRS}^{cs , max}}{2} , … {n}_{SRS}^{cs , max} - 1 \} \\ ( {\overline{k}}_{TC} + hash ( {l}^{′} , {n}_{s} , {n}_{ID} , {p}_{i} ) ) mod {K}_{TC} , otherwise\end{matrix}$$

Where n_{ID} indicates the cell ID or virtual cell ID configured by the gNB by RRC signaling; nₛ indicates the slot index for the SRS transmission occasion; hash( ) indicates a hash function. In an example, the hash function can be defined as follows:

$$hash ( {x}_{1} , {x}_{2} , … {x}_{N} ) = {a}_{1} {x}_{1} + {a}_{2} {x}_{2} + ⋯ + {a}_{N} {x}_{N}$$

where a₁, a₂, . . . , a_{N} is predefined, which may be equal to or more than 0.

In some implementations, the UE 102 determines a comb offset associated with the comb offset hopping for an SRS port for an SRS resource associated with all configured symbols of a slot based on at least one of a symbol index of a first or a last symbol of the SRS resource, a slot index of a first or a last symbol of the SRS resource, a port index, a cell ID, or a virtual cell ID.

The UE 102 might also determine the comb offset based on the first or the last slot, subframe, frame index.

In some other implementations, the UE 102 determines a comb offset associated with comb offset hopping for an SRS port associated with a group of SRS symbols for an SRS resource based on at least one of a symbol index of a first or a last symbol within the group of SRS symbols, a slot index of a first or a last symbol within the group of SRS symbols, a port index, a cell ID, or a virtual cell ID.

The UE 102 might also determine the comb offset for an SRS port in a group of configured/scheduled symbol(s) for an SRS resource based on subframe, frame index within the group of symbols configured via an RRC signaling. A length of a TD-OCC determines the group of symbols. A number of symbols within the group is the same as the length of a TD-OCC code. The symbols with a complete TD-OCC code may be within a group. For example, if a length of 2 TD-OCC is applied, every 2 symbols allocated for an SRS resource form a group.

In some other implementations, the UE 102 determines a comb offset associated with the comb offset hopping for all SRS ports in an SRS symbol based on at least one of a symbol index of the SRS symbol, a slot index of the SRS symbol, a common port index, a cell ID, or a virtual cell ID.

The UE 102 might also determine the comb offset hopping for all SRS ports in an SRS symbol based a subframe or frame index.

In one example, the UE 102 may transmit the SRS at the resource element in resource element (k, l) at antenna port pᵢ for

$${a}_{k , l}^{( {p}_{i} )}$$

as follows:

$${a}_{{K}_{TC} {k}^{′} + {k}_{0}^{( {p}_{i} )} , {l}^{′} + {l}_{0}}^{( {p}_{i} )} = \{ \begin{matrix}\frac{1}{\sqrt{{N}_{ap}}} β {r}^{( {p}_{i} )} ( n , {l}^{′} ) , {k}^{′} = 0 , 1 … {M}_{sc , b}^{SRS} - 1 , {l}^{′} = 0 , 1 , … , {N}_{symb}^{SRS} - 1 \\ 0 , otherwise\end{matrix}$$

### Where

$${k}_{0}^{( {p}_{i} )}$$

is calculated as follows:

$${k}_{0}^{( {p}_{i} )} = {\overline{k}}_{0}^{( {p}_{i} )} + {n}_{offset}^{FH} + {n}_{offset}^{RPFS}$$

$${\overline{k}}_{0}^{( {p}_{i} )} = {n}_{shift} {N}_{sc}^{RB} + ( {k}_{TC}^{′ ( {p}_{i} )} + {k}_{offset}^{{l}^{′}} ) mod {K}_{TC}$$

### Where

$${k}_{TC}^{′ ( {p}_{i} )}$$

is the comb offset for antenna port pᵢ, which is calculated as follows:

$${k}_{TC}^{′ ( {p}_{i} )} = ( {k}_{TC}^{( {p}_{i} )} + hash ( {l}^{′} ) ) mod {K}_{TC}$$

### Alternatively,

$${k}_{TC}^{′ ( {p}_{i} )}$$

is calculated as follows:

$${k}_{TC}^{′ ( {p}_{i} )} = ( {k}_{TC}^{( {p}_{i} )} + hash ( {l}^{′} , {n}_{ID} ) ) mod {K}_{TC}$$

### Alternatively,

$${k}_{TC}^{′ ( {p}_{i} )}$$

is calculated as follows:

$${k}_{TC}^{′ ( {p}_{i} )} = ( {k}_{TC}^{( {p}_{i} )} + hash ( {l}^{′} , {n}_{s} ) ) mod {K}_{TC}$$

### Alternatively,

$${k}_{TC}^{′ ( {p}_{i} )}$$

is calculated as follows:

$${k}_{TC}^{′ ( {p}_{i} )} = ( {k}_{TC}^{( {p}_{i} )} + hash ( {l}^{′} , {n}_{s} , {n}_{ID} ) ) mod {K}_{TC}$$

Where n_{ID} indicates the cell ID or virtual cell ID, and nₛ indicates the slot index.

In some implementations, the UE 102 determines a comb offset associated with the comb offset hopping for all SRS ports in all SRS symbols for an SRS resource based on at least one of a symbol index of a first or a last symbol for the SRS resource, a slot index of a first or a last symbol for the SRS resource, a port index, a cell ID, or a virtual cell ID.

The UE 102 might also determine the comb offset for all SRS ports in all SRS symbols for an SRS resource based on a subframe or a frame index configured via an RRC signaling.

In some other implementations, the UE 102 determines a comb offset associated with the comb offset hopping for all SRS ports in an SRS symbol based on at least one of a symbol index of a first or a last symbol within a group of SRS symbols, a slot index of a first or a last symbol within a group of SRS symbols, a port index, a cell ID, or a virtual cell ID. The UE 102 might also determine the comb offset for all SRS ports in all SRS symbols for an SRS resource based a first or a last subframe or a frame index configured via an RRC signaling.

After the UE determines the comb offset, the UE 102, transmits to the network entity 104, the SRS.

The network entity 104 determines 330 the comb offset for the triggered SRS and receive the triggered SRS based on the determined comb offset.

Referring to FIG. 3B, the procedures 320, 326, 328, 330 may be similar to procedures 320, 326, 328, 330 of FIG. 3A.

The network entity 104, transmits 352, to the UE 102 an SRS-randomization configuration to configure at least one SRS resource and optionally to configure candidate comb offsets set(s) for comb hopping. The SRS-randomizing configuration indicates candidate resources for the transmitting of the SRS, and the SRS is transmitted on one of the candidate resources. The SRS-randomization configuration enables the comb offset hopping. The SRS-randomization configuration indicates the candidate comb offset for the triggered SRS.

In some examples, the UE capability report might include a maximum number of supported candidate comb offsets. The maximum number of supported candidate comb offsets may be calculated per component carrier (CC), per band, per band combination, or per UE.

In some other examples, the network entity 104 might configure a list of candidate comb offsets sets via an RRC signaling. In one example, the network entity 104 may indicate the comb offsets set index for a semi-persistent SRS resource set via MAC-CE. In another example, the network entity 104 may indicate the comb offsets set index for an aperiodic SRS resource set via a DCI. To multiplex the generated SRS using interference randomization as described above with a legacy SRS, the network entity 104 can configure the candidate comb offsets that are not used for the legacy SRS.

In some implementations, the network entity 104 may configure a set of comb offsets (e.g., combOffsetSet) via an RRC signaling for an SRS resource. In some other implementations, the network entity 104 may configure a list of comb offsets sets via the RRC signaling for an SRS resource. In some implementations, the network entity 104 may select the comb offset by indicating a set index in MAC-CE or DCI.

The network entity 104, transmits 354, to the UE 102, control signaling to trigger an SRS resource set with at least one SRS resource with comb offset hopping and/or to enable comb hopping and optionally indicate the selected comb offsets set.

In one example, the UE transmit the SRS at the resource element in resource element (k, l) at antenna port pᵢ for

$${a}_{k , l}^{( {p}_{i} )}$$

as follows:

$${a}_{{K}_{TC} {k}^{′} + {k}_{0}^{( {p}_{i} )} , {l}^{′} + {l}_{0}}^{( {p}_{i} )} = \{ \begin{matrix}\frac{1}{\sqrt{{N}_{ap}}} β {r}^{( {p}_{i} )} ( n , {l}^{′} ) , {k}^{′} = 0 , 1 , … {M}_{sc , b}^{SRS} - 1 , {l}^{′} = 0 , 1 , … , {N}_{symb}^{SRS} - 1 \\ 0 , otherwise\end{matrix}$$

Where

$${k}_{0}^{( {p}_{i} )}$$

is calculated as follows:

$${k}_{0}^{( {p}_{i} )} = {\overline{k}}_{0}^{( {p}_{i} )} + {n}_{offset}^{FH} + {n}_{offset}^{RPFS}$$

$${\overline{k}}_{0}^{( {p}_{i} )} = {n}_{shift} {N}_{sc}^{RB} + ( {k}_{TC}^{( {p}_{i} )} + {k}_{offset}^{{l}^{′}} ) mod {K}_{TC}$$

Where

$${k}_{TC}^{( {p}_{i} )}$$

is the comb offset for antenna port pᵢ, which is calculated as follows:

$${k}_{TC}^{( {p}_{i} )} = \{ \begin{matrix}( {\overline{k}}_{TC}^{′} ( s ) + \frac{{K}_{TC}}{2} ) mod {K}_{TC} , if {N}_{ap}^{SRS} = 4 , {p}_{i} ∈ \{ 1001 , 1003 \} , {n}_{SRS}^{cs , max} = 6 \\ ( {\overline{k}}_{TC}^{′} ( s ) + \frac{{K}_{TC}}{2} ) mod {K}_{TC} , if {N}_{ap}^{SRS} = 4 , {p}_{i} ∈ \{ 1001 , 1003 \} , {n}_{SRS}^{cs} ∈ \{ \frac{{n}_{SRS}^{cs , max}}{2} , … {n}_{SRS}^{cs , max} - 1 \} \\ ( {\overline{k}}_{TC}^{′} ( s ) ) mod {K}_{TC} , otherwise\end{matrix}$$

Where k̅′_{TC} is the comb offsets configured by RRC signaling by the gNB, and s is calculated by as follows:

$$s = hash ( {n}_{s} , {l}^{′} , {p}_{i} ) mod {N}_{k}$$

Alternatively, s is calculated by as follows:

$$s = hash ( {n}_{s} , {l}^{′} , {n}_{ID} , {p}_{i} ) mod {N}_{k}$$

Alternatively, s is calculated by as follows:

$$s = hash ( {l}^{′} , {n}_{ID} , {p}_{i} ) mod {N}_{k}$$

Alternatively, s is calculated by as follows:

$$s = hash ( {l}^{′} , {p}_{i} ) mod {N}_{k}$$

Where hash( ) indicates a hash function; Nₖ is the number of candidate comb offsets in the comb offset set. In an example, the hash function can be defined as follows:

$$hash ( {x}_{1} , {x}_{2} , … {x}_{N} ) = {a}_{1} {x}_{1} + {a}_{2} {x}_{2} + ⋯ + {a}_{N} {x}_{N}$$

where a₁, a₂, . . . , a_{N} is predefined, which may be equal to or more than 0.

In some examples, Where k̅′_{TC} is the comb offsets configured by RRC signaling by the gNB, and s is calculated by as follows:

$$s = hash ( {n}_{s} , {l}^{′} ) mod {N}_{k}$$

Alternatively, s is calculated by as follows:

$$s = hash ( {n}_{s} , {l}^{′} , {n}_{ID} ) mod {N}_{k}$$

Alternatively, s is calculated by as follows:

$$s = hash ( {l}^{′} , {n}_{ID} ) mod {N}_{k}$$

Alternatively, s is calculated by as follows:

$$s = hash ( {l}^{′} ) mod {N}_{k}$$

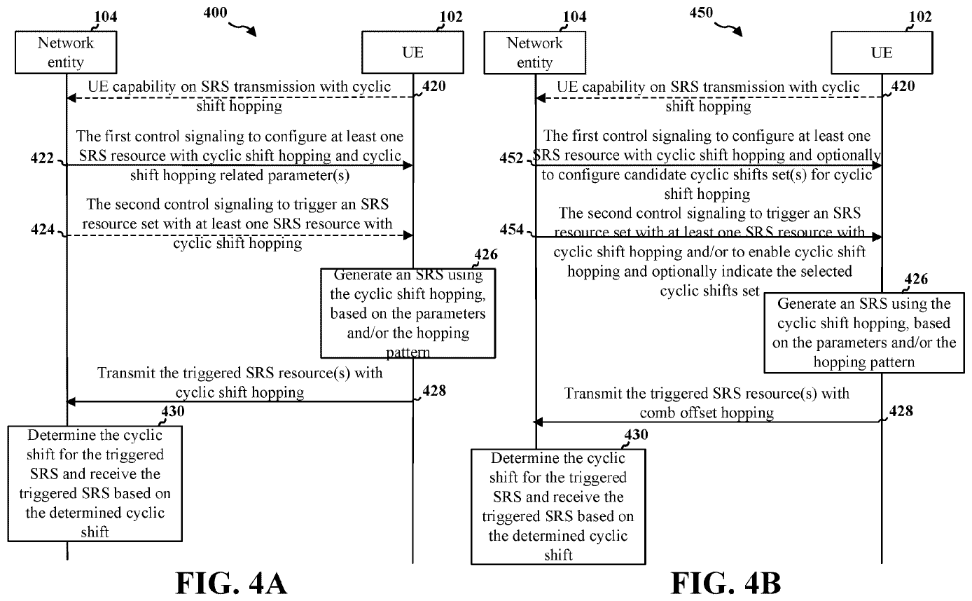

FIGS. 3A-3B illustrate example procedures for an SRS signal interference randomization using a comb offset hopping. FIGS. 4A-4B example procedures for an SRS signal interference randomization using a cyclic shift hopping.

FIGS. 4A-4B are signaling diagrams 400-450 for an SRS signal interference randomization. In particular, the signaling diagram 400 illustrates an example of an SRS signal interference randomization using a cyclic shift hopping, whereas the signaling diagram 450 illustrates another example of an SRS signal interference randomization using a cyclic shift hopping. Example procedures 400-450 can be implemented by the UE 102 communicating with the network entity 104 depicted in FIG. 1.

Referring to FIG. 4A, initially, a UE 102 might transmit 420, to a network entity 104, a UE capability report. For example, the UE 102 transmits 420, to the network entity 104, the UE capability report regarding an SRS transmission with a cyclic shift hopping. The UE capability report includes an indication that indicates a UE's ability to apply the cyclic shift hopping. The UE capability report further includes at least one of an indication of a supported time domain behavior for the SRS with the cyclic shift hopping (e.g., periodic/semi-persistent/aperiodic; supported usage of SRS with the cyclic shift hopping).

In some examples, the network entity 104 might receive, from a core network (e.g., Access and Mobility Management Function (AMF)), the UE capability report. In some other examples, the network entity might receive, from another base station (e.g., gNB or eNB), the UE capability report. Based on the UE capability report, the network entity 104 might configure at least one SRS resource in one SRS resource set with a cyclic shift and cyclic shift related parameters. In some other examples, the network entity 104 might transmit, to the UE, an RRC message (e.g., RRCReconfiguration message) to configure a periodicity and a slot offset for a periodic SRS. For a semi-persistent SRS, the network entity 104 might transmit, to the UE 102, a MAC-CE to trigger a transmission. For a aperiodic SRS, the network entity 104 might transmit, to the UE 102, a DCI to trigger the transmission. For each transmission occasion for a triggered SRS resource with a cyclic shift hopping, the UE 102 determines a cyclic shift for each transmission occasion. Then, the UE 102 transmits the SRS based on the determined cyclic shift. The network entity 104 determines the cyclic shift for the triggered SRS resource and receives the SRS based on the determined cyclic shift.

The network entity 104 transmits 422, to the UE 102, an SRS-randomization configuration including parameters and/or a hopping pattern to apply the cyclic shift hopping.

In some examples, the network entity 104 transmits 422 an RRC parameter to enable or disable the cyclic shift hopping for an SRS resource or for an SRS resource set. In some other examples, the cyclic shift hopping is applicable for all types of SRS (e.g. periodic/semi-persistent/aperiodic). In some other examples, the cyclic shift hopping is applicable for some types of SRS (e.g. periodic/semi-persistent), SRS with a potential usage (e.g., SRS for AS/BM/CB/NCB).

In one example, the network entity 104 may transmit an RRC parameter cyclicShiftHopping in an SRS resource to provide the indication of enabling/disabling cyclic shift hopping for the SRS resource. If the RRC parameter is present, the cyclic shift hopping is enabled; otherwise, the cyclic shift hopping is disabled.

In another example, the network entity 104 may transmit an RRC parameter cyclicShiftHopping in an SRS resource set to provide the indication of enabling/disabling cyclic shift hopping for the SRS resources within the SRS resource set. If the RRC parameter is present, the cyclic shift hopping is enabled; otherwise, the cyclic shift hopping is disabled.

The network entity 104 might transmit 424 control signaling that triggers the SRS using the cyclic shift hopping.

The UE 102 generates 426 an SRS using the cyclic shift hopping based on the parameters and/or the hopping pattern. To generate the SRS, the UE 102 determines the cyclic shift for the triggered SRS resource with the cyclic shift hopping.

In some examples, the UE 102 determines a cyclic shift associated with the cyclic shift hopping for an SRS port corresponding to a symbol for an SRS resource based on at least one of a symbol index, a slot index, a port index, a cell identifier (ID), or a virtual cell ID.

In some examples, the UE 102 determines a cyclic shift associated with the cyclic shift hopping for an SRS port associated with all symbols for an SRS resource based on at least one of a symbol index of a first or a last symbol for the SRS resource, a slot index of a first or a last symbol for the SRS resource, a port index, a cell ID, or a virtual cell ID.

In some examples, the UE 102 determines a cyclic shift associated with the cyclic shift hopping for an SRS port associated with a group of SRS symbols for an SRS resource based on at least one of a symbol index of a first or a last symbol within the group of SRS symbols, a slot index of a first or a last symbol within the group of SRS symbols, a port index, a cell ID, or a virtual cell ID.

In one example, the UE generates the sequence for an SRS port pᵢ in symbol l′ as follows:

$${r}^{( {p}_{i} )} ( n , {l}^{′} ) = {r}_{u , v}^{( {α}_{i} , δ )} ( n )$$

$$n = 0 , 1 , … {M}_{sc , b}^{SRS} - 1$$

Where the sequence

$${r}_{u , v}^{( α , δ )} ( n )$$

is a low peak average power ratio (PAPR) sequence generated. The cyclic shift αᵢ is calculated as follows:

$${α}_{i} = 2 π \frac{{\tilde{n}}_{SRS}^{cs , i}}{{n}_{SRS}^{cs , max}}$$

Where

$${\tilde{n}}_{SRS}^{cs , i}$$

is calculated as follows:

$${\tilde{n}}_{SRS}^{cs , i} = ( {n}_{SRS}^{cs , i} + hash ( {l}^{′} ) ) mod {n}_{SRS}^{cs , max}$$

Alternatively,

$${\tilde{n}}_{SRS}^{cs , i}$$

is calculated as follows:

$${\tilde{n}}_{SRS}^{cs , i} = ( {n}_{SRS}^{cs , i} + hash ( {l}^{′} , {n}_{ID} ) ) mod {n}_{SRS}^{cs , max}$$

Alternatively,

$${\tilde{n}}_{SRS}^{cs , i}$$

is calculated as follows:

$${\tilde{n}}_{SRS}^{cs , i} = ( {n}_{SRS}^{cs , i} + hash ( {l}^{′} , {n}_{s} ) ) mod {n}_{SRS}^{cs , max}$$

Alternatively,

$${\tilde{n}}_{SRS}^{cs , i}$$

is calculated as follows:

$${\tilde{n}}_{SRS}^{cs , i} = ( {n}_{SRS}^{cs , i} + hash ( {l}^{′} , {n}_{s} , {n}_{ID} ) ) mod {n}_{SRS}^{cs , max}$$

Where hash( ) indicates a hash function. In an example, the hash function can be defined as follows:

$$hash ( {x}_{1} , {x}_{2} , … {x}_{N} ) = {a}_{1} {x}_{1} + {a}_{2} {x}_{2} + ⋯ + {a}_{N} {x}_{N}$$

where a₁, a₂, . . . , a_{N} may be predefined, which may be equal to or more than 0.

The UE 102, transmits 428, to the network entity 104, the SRS.

The network entity 104 determines 430 the cyclic shift for the triggered SRS and receive the triggered SRS based on the determined cyclic shift.

Referring to FIG. 4B, the procedures 420, 426, 428, 430 may be similar to procedures 420, 426, 428, 430 of FIG. 4A.

The network entity 104, transmits 452, to the UE 102 an SRS-randomization configuration to configure at least one SRS resource and optionally to configure candidate cyclic shift set(s) for cyclic shift hopping. The SRS-randomizing configuration indicates candidate resources for the transmitting of the SRS, and the SRS is transmitted on one of the candidate resources.

In some examples, for the SRS resource with the cyclic shifts set configured, in 326, the UE determines the cyclic shift for the SRS port(s) in a configured/scheduled symbol based on the configured/indicated cyclic shifts set, the symbol/slot/subframe/frame index and/or cell ID or virtual cell identifier (ID), e.g., sequenceId, configured by RRC signaling by the gNB.

In one example, the UE 102 generates the sequence for an SRS port pᵢ in symbol l′ as follows:

$${r}^{( {p}_{i} )} ( n , {l}^{′} ) = {r}_{u , v}^{( {α}_{i} δ )} ( n )$$

$$n = 0 , 1 , … {M}_{sc , b}^{SRS} - 1$$

Where the sequence

$${r}_{u , v}^{( α , δ )} ( n )$$

is a low peak average power ratio (PAPR) sequence generated as section 5.2.2 in 38.111. The cyclic shift αᵢ is calculated as follows:

$${α}_{i} = 2 π \frac{{\hat{n}}_{SRS}^{cs , i} ( S )}{{n}_{SRS}^{cs , max}}$$

Where

$${\hat{n}}_{SRS}^{cs , i}$$

is the cyclic snits configured in the cyclic shifts set; s is calculated as follows:

$$s = h a sh ( {n}_{s} , {l}^{′} ) mod {S}_{k}$$

Alternatively, s is calculated by as follows:

$$s = hash ( {n}_{s} , {l}^{′} , {n}_{ID} ) mod {S}_{k}$$

Alternatively, s is calculated by as follows:

$$s = h a sh ( {l}^{′} , {n}_{ID} ) mod {S}_{κ}$$

Alternatively, s is calculated by as follows:

$$s = hash ( {l}^{′} ) mod {S}_{k}$$

Where Sₖ is the number of cyclic shifts configured in the cyclic shifts set; hash( ) indicates a hash function. In an example, the hash function can be defined as follows:

$$hash ( {x}_{1} , {x}_{2} , … {x}_{N} ) = {a}_{1} {x}_{1} + {a}_{2} {x}_{2} + … + {a}_{N} {x}_{N}$$

where a₁, a₂ . . . , a_{N} may be predefined, which may be equal to or more than 0.

The network entity 104, transmits, to the UE 102, 454 control signaling to trigger an SRS resource set with at least one SRS resource with cyclic shift hopping and/or to enable cyclic shift hopping and optionally indicate the selected cyclic shift set.

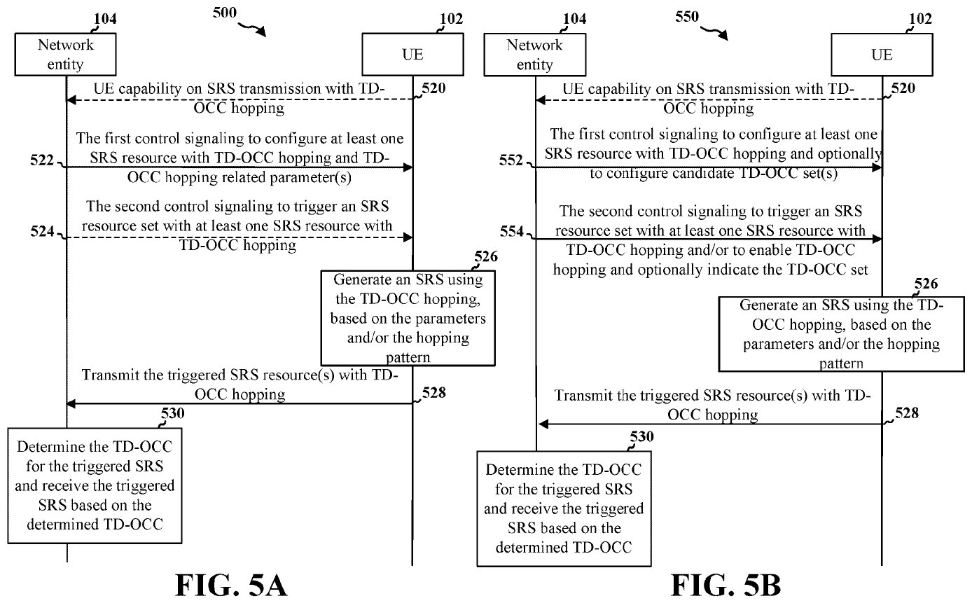

FIGS. 4A-4B illustrate example procedures for an SRS signal interference randomization using the cyclic shift hopping. FIGS. 5A-5B example procedures for an SRS signal interference randomization using a TD-OCC hopping.

FIGS. 5A-5B are signaling diagrams 500-550 for an SRS signal interference randomization. In particular, the signaling diagram 500 illustrates an example of an SRS signal interference randomization using a TD-OCC hopping, whereas the signaling diagram 550 illustrates another example of an SRS signal interference randomization using the TD-OCC hopping. Example procedures 500-550 can be implemented by the UE 102 communicating with the network entity 104 depicted in FIG. 1.

Referring to FIG. 5A, initially, a UE 102 might transmit 520, to a network entity 104, a UE capability report. For example, the UE 102 transmits 520, to the network entity 104, the UE capability report regarding an SRS transmission with a TD-OCC hopping. The UE capability report includes an indication that indicates a UE's ability to apply the TD-OCC hopping. The UE capability report further includes at least one of an indication of a supported time domain behavior for the SRS with comb hopping (e.g., periodic/semi-persistent/aperiodic; supported usage of SRS with comb hopping).

The network entity 104 transmits 522, to the UE 102, an SRS-randomization configuration including parameters and/or a hopping pattern to apply the TD-OCC hopping.

In some examples, the network entity 104 might transmit the SRS-randomization configuration via RRC signaling, which may indicate parameters such as tdOccHopping, to enable or disable the TD-OCC hopping for an SRS resource. In some examples, the TD-OCC hopping is applicable for all types of SRS (e.g., periodic/semi-persistent/aperiodic). In some other examples, the TD-OCC hopping is applicable for some types of SRS (e.g., periodic/semi-persistent), SRS with a potential usage (e.g., SRS for AS/BM/CB/NCB). In some other examples, to multiplex the generated SRS and a legacy SRS without the TD-OCC enabled, the TD-OCC code is set with all ones, e.g., [1, 1] for a length-2 TD-OCC or [1, 1, 1, 1] for a length-4 TD-OCC.

In some examples, the TD-OCC length might be the same as the number of symbols. Then, the network entity 104 may configure whether TD-OCC is enabled or not via RRC signaling, which may indicate parameters, e.g. enableTdOcc. In some other examples, the network entity 104 may configure the TD-OCC length by a separate RRC signaling, which may indicate parameter, e.g. tdOccLength. In this example, the TD-OCC length may be smaller than or equal to the number of symbols. In some other examples, the network entity 104 may configure the TD-OCC length via MAC-CE or DCI. In one example, for semi-persistent SRS, the network entity 104 may configure the TD-OCC for each active SRS resource via MAC-CE. In another example, for aperiodic SRS, the network entity 104 may configure the TD-OCC for the aperiodic SRS via DCI.

In one example, the network entity 104 may transmit RRC signaling, which may indicate parameters enableTdOcc and tdOccHopping in an SRS resource to provide an indication of enabling/disabling cyclic shift hopping for the SRS resource. If the parameter is present, the cyclic shift hopping is enabled; otherwise, the cyclic shift hopping is disabled.

In another example, the network entity 104 may transmit RRC signaling, which may indicate parameters tdOccLength and an RRC parameter tdOccHopping in an SRS resource to provide the indication of enabling/disabling cyclic shift hopping for the SRS resource. If the RRC parameter is present, the cyclic shift hopping is enabled; otherwise, the cyclic shift hopping is disabled.

The network entity 104 might transmit 524, to the UE, control signaling that triggers the SRS using the TD-OCC hopping.

The UE 102 the UE 102 generates 526 an SRS using the TD-OCC hopping based on the parameters and/or the hopping pattern. To generate the SRS, the UE 102 determines the TD-OCC for the triggered SRS resource with the TD-OCC hopping.

In some examples, the UE 102 determines a comb offset associated with the TD-OCC hopping for an SRS port corresponding to a symbol based on at least one of a symbol index, a slot index, a port index, a cell identifier (ID), or a virtual cell ID (e.g., sequenceId). The UE 102 might also determine the TD-OCC for the SRS port in a configured/scheduled symbol based on a subframe or a frame index configured via an RRC signaling.

In some other examples, the UE 102 determines a TD-OCC associated with the TD-OCC hopping for an SRS port associated with all symbols of a slot are each based on at least one of a symbol index, a slot index of a first or a last symbol, a port index, a cell ID, or a virtual cell ID.

In some examples, for the SRS resource with the TD-OCC hopping enabled, the UE 102 determines the TD-OCC for the SRS port(s) in the configured/scheduled symbol(s) based on the symbol/slot/subframe/frame index for the first/last symbol of the SRS resource and/or cell ID or virtual cell identifier (ID), e.g., sequenceId, configured by RRC signaling by the gNB.

In one example, the UE transmit the SRS at the resource element in resource element (k, l) at antenna port pᵢ for

$${a}_{k , l}^{( {p}_{i} )}$$

as follows:

$${a}_{{K}_{TC} {k}^{′} + {k}_{0}^{( {p}_{i} )} , {l}^{′} + {l}_{0}}^{( {p}_{i} )} = \{ \begin{matrix}\begin{matrix}\frac{1}{\sqrt{{N}_{ap}}} β {W}_{t}^{( {p}_{i} )} ( {l}^{′} , mod {L}_{t} ) {r}^{( {p}_{i} )} ( n , {l}^{′} ) , \\ {k}^{′} = 0 , 1 , … {M}_{sc , b}^{SRS} - 1 , {l}^{′} = 0 , 1 , … , {N}_{symb}^{SRS} - 1\end{matrix} \\ 0 , otherwise\end{matrix}$$

Where

$${W}_{t}^{( {p}_{i} )}$$

is the TD-OCC code applied to the SRS symbol l′; Lₜ is the length of the TD-OCC. In one example, for length 2 TD-OCC, the candidate code can be [1, 1] or [1, −1].

The selected TD-OCC code index s to determine

$${W}_{t}^{( {p}_{i} )}$$

for the SRS symbols could be determined as follows:

$$s = hash ( {n}_{s} , {l}_{0} , {p}_{i} ) mod {L}_{t}$$

Alternatively, s is calculated by as follows:

$$s = hash ( {n}_{s} , {l}_{0} , {n}_{ID} , {p}_{i} ) mod {L}_{t}$$

Alternatively, s is calculated by as follows:

$$s = hash ( {l}_{0} , {n}_{ID} , {p}_{i} ) mod {L}_{t}$$

Alternatively, s is calculated by as follows:

$$s = hash ( {l}_{0} , {p}_{i} ) mod {L}_{t}$$

Alternatively, s is calculated by as follows:

$$s = hash ( {n}_{s} , {n}_{ID} , {p}_{i} ) mod {L}_{t}$$

Alternatively, s is calculated by as follows:

$$s = hash ( {n}_{s} , {p}_{i} ) mod {L}_{t}$$

Where l₀ is the symbol index of the first symbol for the SRS resource, nₛ is the slot index for the first symbol of the SRS resource, and n_{ID} is the cell ID or virtual cell ID.

The UE 102, transmits 528, to the network entity 104, the SRS.

The network entity 104 determines 530 the TD-OCC for the triggered SRS and receive the triggered SRS based on the determined TD-OCC.

Referring to FIG. 5B, the procedures 520, 526, 528, 530 may be similar to procedures 520, 526, 528, 530 of FIG. 5A.

The network entity 104, transmits 552, to the UE 102 an SRS-randomization configuration to configure at least one SRS resource and optionally to configure candidate TD-OCCs for TD-OCC hopping. The SRS-randomizing configuration indicates candidate resources for the transmitting of the SRS, and the SRS is transmitted on one of the candidate resources.

The network entity 104, transmits, to the UE 102, 554 control signaling to trigger an SRS resource set with at least one SRS resource with TD-OCC hopping and/or to enable TD-OCC hopping and optionally indicate the selected TD-OCC set.

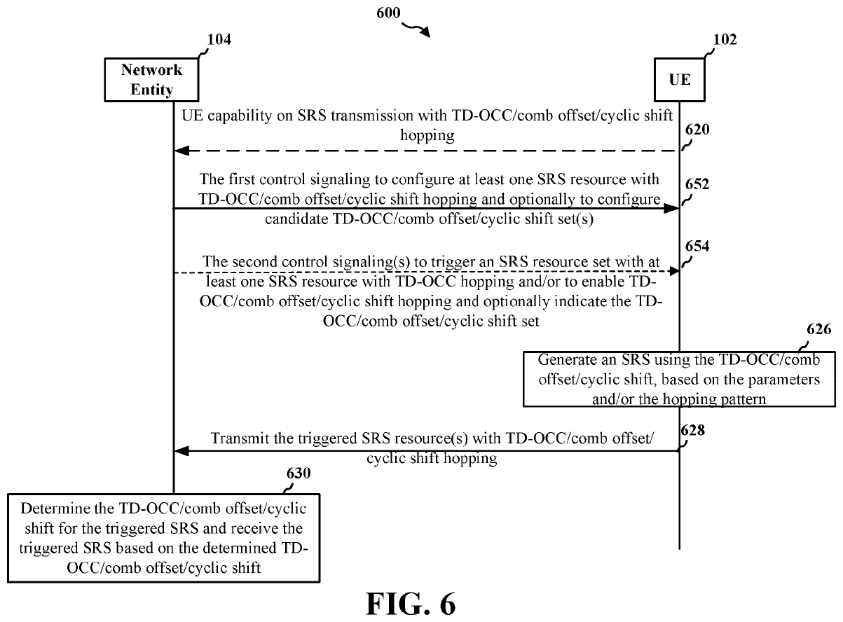

FIGS. 5A-5B illustrate example procedures for an SRS signal interference randomization using the TD-OCC hopping. FIG. 6 is an example procedure for an SRS signal interference randomization using one of a comb offset hopping, a cyclic shift, or a TD-OCC hopping.

FIG. 6 is a signaling diagram 600 for an SRS signal interference randomization. In particular, the signaling diagram 600 illustrates an example of an SRS signal interference randomization using one of a comb offset hopping, a cyclic shift, or a TD-OCC hopping. Example procedure 600 can be implemented by the UE 102 communicating with the network entity 104 depicted in FIG. 1.

Referring to FIG. 6, initially, a UE 102 might transmit 620, to a network entity 104, a UE capability report. For example, the UE 102 transmits 620, to the network entity 104, the UE capability report regarding an SRS transmission with a comb offset hopping, a cyclic shift, or a TD-OCC hopping. The UE capability report includes an indication that indicates a UE's ability to apply one of a comb offset hopping, a cyclic shift, or a TD-OCC hopping. The UE capability report further includes at least one of an indication of a supported time domain behavior for the SRS with one of a comb offset hopping, a cyclic shift, or a TD-OCC hopping (e.g., periodic/semi-persistent/aperiodic; supported usage of SRS with comb hopping).

The network entity 104 transmits 652, to the UE 102, an SRS-randomization configuration to configure at least one SRS resource with one of a comb offset hopping, a cyclic shift, or a TD-OCC hopping and optionally to configure candidate one of a comb offset hopping, a cyclic shift, or a TD-OCC hopping.

The network entity 104 might transmit 654, to the UE, control signaling that triggers the SRS using one of a comb offset hopping, a cyclic shift, or a TD-OCC hopping. The network entity 104 may transmit a single control signaling or a separate control signaling to enable one of the comb offset, the cyclic shift, or TD-OCC hopping separately.

The UE 102 generates 626 an SRS using the one of a comb offset hopping, a cyclic shift, or a TD-OCC hopping based on the parameters and/or the hopping pattern. To generate the SRS, the UE 102 determines the one of a comb offset, a cyclic shift, or a TD-OCC for the triggered SRS resource with the one of a comb offset hopping, a cyclic shift, or a TD-OCC hopping.

The UE 102, transmits 628, to the network entity 104, the SRS.

The network entity 104 determines 630 one of a comb offset, a cyclic shift, or a TD-OCC for the triggered SRS and receive the triggered SRS based on the determined comb offset hopping, cyclic shift, or TD-OCC.

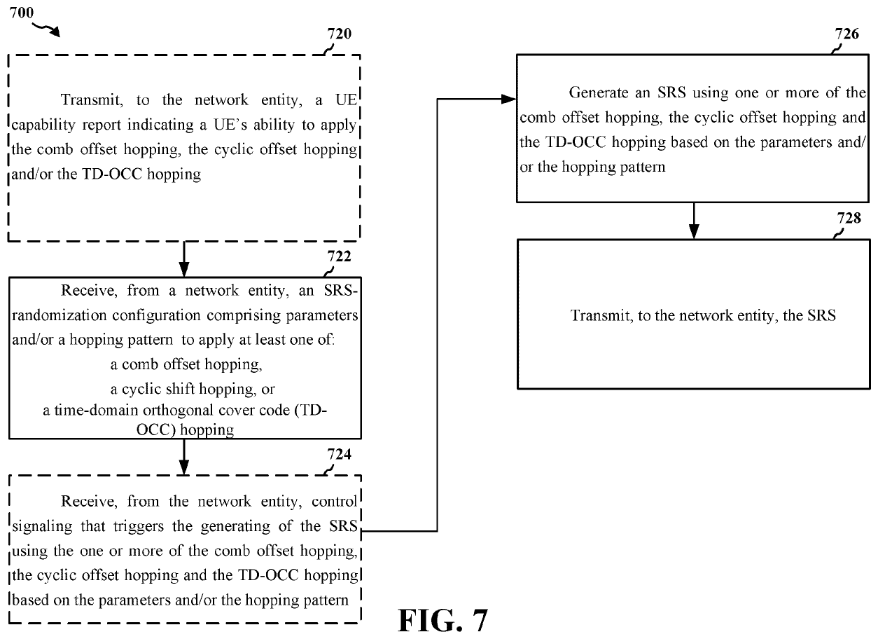

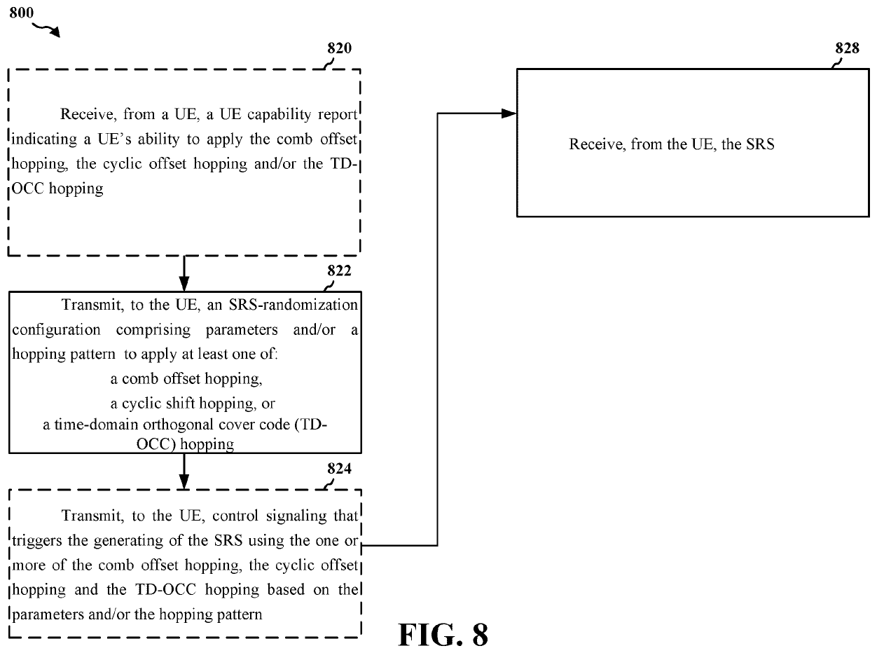

FIGS. 3A-6 illustrate example procedures for an SRS signal interference randomization using a comb offset hopping, a cyclic shift hopping, and a TD-OCC hopping. FIGS. 7-8 show methods for implementing one or more aspects of FIGS. 3A-6. In particular, FIG. 7 shows an implementation by the UE 102 of the one or more aspects of FIGS. 3A-6. FIG. 8 shows an implementation by the network entity 104 of the one or more aspects of FIGS. 3A-6.

FIG. 7 illustrates a flowchart 700 of a method of wireless communication at a UE 102. With reference to FIGS. 1-6, 9 and 10, the method may be performed by the UE 102, the UE apparatus 902, etc., which may include the memory 906′ and which may correspond to the entire UE 102 or the UE apparatus 902, or a component of the UE 102 or the UE apparatus 902, such as the wireless baseband processor 926, and/or the application processor 906.

The UE 102 might transmit 720, to the network entity, a UE capability report indicating a UE's ability to apply the comb offset hopping, the cyclic shift hopping and/or the TD-OCC hopping. Referring to FIGS. 3A-6, for example, the UE transmits 320, 420, 520, 620 to the network entity, a UE capability report indicating a UE's ability to apply the comb offset hopping, the cyclic shift hopping and/or the TD-OCC hopping.

The UE 102 receives 722, from a network entity 104, an SRS-randomization configuration comprising parameters and/or a hopping pattern to apply at least one of: a comb offset hopping, a cyclic shift hopping, or a TD-OCC hopping. Referring to FIGS. 3A-6, for example, the UE 102 receives 322, 422, 522, 652 from a network entity 104, an SRS-randomization configuration comprising parameters and/or a hopping pattern to apply at least one of: a comb offset hopping, a cyclic shift hopping, or a TD-OCC hopping.

The UE 102 might receive 724, from the network entity 104, control signaling that triggers the generating of the SRS using the one or more of the comb offset hopping, the cyclic shift hopping and the TD-OCC hopping based on the parameters and/or the hopping pattern. Referring to FIGS. 3A-6, for example, the UE 102 receives 324, 424, 524, 654 from a network entity 104, control signaling that triggers the generating of the SRS using the one or more of the comb offset hopping, the cyclic shift hopping and the TD-OCC hopping based on the parameters and/or the hopping pattern.

The UE 102 generates 726 an SRS using one or more of the comb offset hopping, the cyclic shift hopping and the TD-OCC hopping based on the parameters and/or the hopping pattern. Referring to FIGS. 3A-6, for example, the UE 102 generates 326, 426, 526, 626 an SRS using one or more of the comb offset hopping, the cyclic shift hopping and the TD-OCC hopping based on the parameters and/or the hopping pattern.

The UE transmits 728, to the network entity, the SRS. Referring to FIGS. 3A-6, for example, the UE 102 transmits 328, 428, 528, 628 the SRS.

FIG. 7 describes a method from a UE-side of a wireless communication link, whereas FIG. 8 describes a method from a network-side of the wireless communication link.

FIG. 8 is a flowchart 800 of a method of wireless communication at a network entity 104. With reference to FIGS. 1-6, 9 and 10, the method may be performed by one or more network entities 104, which may correspond to a base station or a unit of the base station, such as the RU 106, the DU 108, the CU 110, an RU processor 1006, a DU processor 1026, a CU processor 1046, etc. The one or more network entities 104 may include the memory 1006′/1026′/1046′, which may correspond to an entirety of the one or more network entities 104, or a component of the one or more network entities 104, such as the RU processor 1006, the DU processor 1026, or the CU processor 1046.

The one or more network entities 104 might receive 820, from a UE 102, a UE capability report indicating a UE's ability to apply the comb offset hopping, the cyclic shift hopping and/or the TD-OCC hopping. Referring to FIGS. 3A-6, for example, the network entity 104 receives 320, 420, 520, 620 from a UE 102, a UE capability report indicating a UE's ability to apply the comb offset hopping, the cyclic shift hopping and/or the TD-OCC hopping.

The one or more network entities 104 transmits 822, to the UE 102, an SRS-randomization configuration comprising parameters and/or a hopping pattern to apply at least one of: a comb offset hopping, a cyclic shift hopping, or a TD-OCC hopping. Referring to FIGS. 3A-6, for example, the network entity 104 transmits 322, 422, 522, 652, to the UE 102, an SRS-randomization configuration comprising parameters and/or a hopping pattern to apply at least one of: a comb offset hopping, a cyclic shift hopping, or a TD-OCC hopping.

The one or more network entities 104 transmit 824, to the UE 102, control signaling that triggers the generating of the SRS using the one or more of the comb offset hopping, the cyclic shift hopping and the TD-OCC hopping based on the parameters and/or the hopping pattern. Referring to FIGS. 3A-6, for example, the network entity 104 transmits 324, 424, 524, 654, to the UE 102, control signaling that triggers the generating of the SRS using the one or more of the comb offset hopping, the cyclic shift hopping and the TD-OCC hopping based on the parameters and/or the hopping pattern.

The one or more network entities 104 receive 828, from the UE, the SRS. Referring to FIGS. 3A-6, for example, the network entity 104 receives 328, 428, 528, 628 from the UE, the SRS.

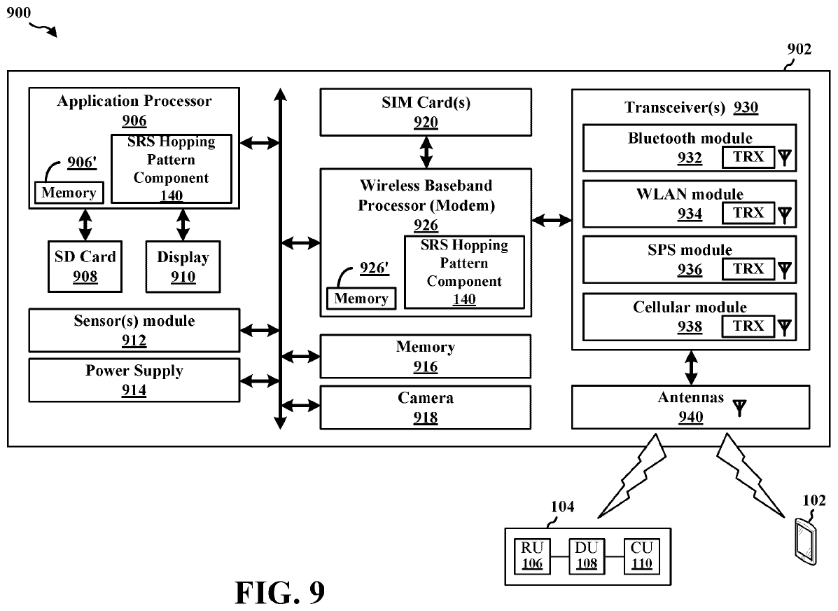

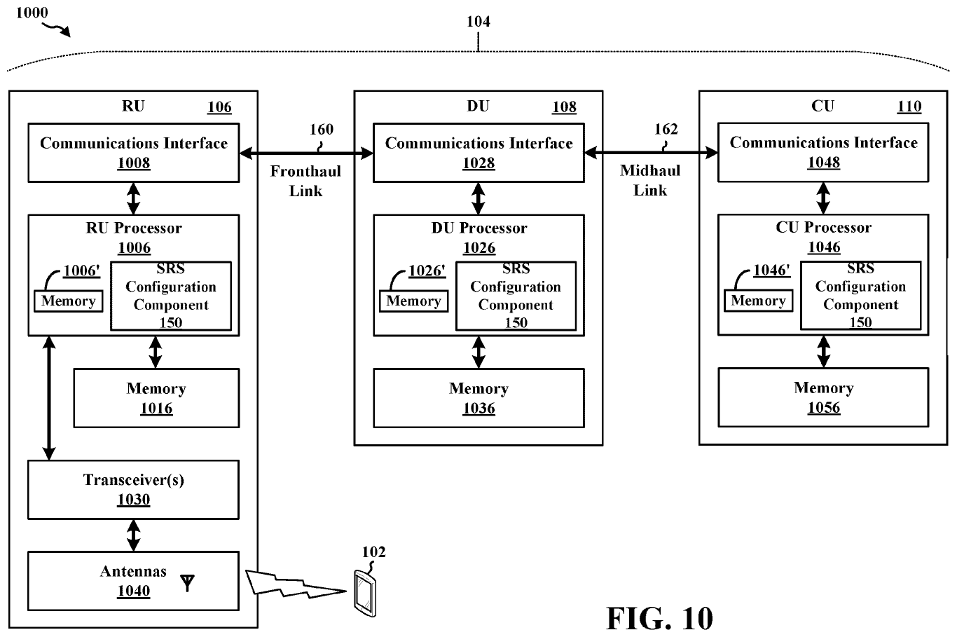

A UE apparatus 902, as described in FIG. 9, may perform the method of flowchart 700. The one or more network entities 104, as described in FIG. 10, may perform the method of flowchart 800.

FIG. 9 is a diagram illustrating an example of a hardware implementation for a UE apparatus 902. The UE apparatus 902 may be the UE 102, a component of the UE 102, or may implement UE functionality. The UE apparatus 902 may include an application processor 906, which may have on-chip memory 906′. In examples, the application processor 906 may be coupled to a secure digital (SD) card 908 and/or a display 910. The application processor 906 may also be coupled to a sensor(s) module 912, a power supply 914, an additional module of memory 916, a camera 918, and/or other related components. For example, the sensor(s) module 912 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 902 may further include a wireless baseband processor 926, which may be referred to as a modem. The wireless baseband processor 926 may have on-chip memory 926′. Along with, and similar to, the application processor 906, the wireless baseband processor 926 may also be coupled to the sensor(s) module 912, the power supply 914, the additional module of memory 916, the camera 918, and/or other related components. The wireless baseband processor 926 may be additionally coupled to one or more subscriber identity module (SIM) card(s) 920 and/or one or more transceivers 930 (e.g., wireless RF transceivers).

Within the one or more transceivers 930, the UE apparatus 902 may include a Bluetooth module 932, a WLAN module 934, an SPS module 936 (e.g., GNSS module), and/or a cellular module 938. The Bluetooth module 932, the WLAN module 934, the SPS module 936, and the cellular module 938 may each include an on-chip transceiver (TRX), or in some cases, just a transmitter (TX) or just a receiver (RX). The Bluetooth module 932, the WLAN module 934, the SPS module 936, and the cellular module 938 may each include dedicated antennas and/or utilize antennas 940 for communication with one or more other nodes. For example, the UE apparatus 902 can communicate through the transceiver(s) 930 via the antennas 940 with another UE 102 (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 926 and the application processor 906 may each include a computer-readable medium/memory 926′, 906′, respectively. The additional module of memory 916 may also be considered a computer-readable medium/memory. Each computer-readable medium/memory 926′, 906′, 916 may be non-transitory. The wireless baseband processor 926 and the application processor 906 may each be responsible for general processing, including execution of software stored on the computer-readable medium/memory 926′, 906′, 916. The software, when executed by the wireless baseband processor 926/application processor 906, causes the wireless baseband processor 926/application processor 906 to perform the various functions described herein. The computer-readable medium/memory may also be used for storing data that is manipulated by the wireless baseband processor 926/application processor 906 when executing the software. The wireless baseband processor 926/application processor 906 may be a component of the UE 102. The UE apparatus 902 may be a processor chip (e.g., modem and/or application) and include just the wireless baseband processor 926 and/or the application processor 906. In other examples, the UE apparatus 902 may be the entire UE 102 and include the additional modules of the apparatus 902.

As discussed, the SRS hopping pattern component 140 is configured to receive, from a network entity, an SRS-randomization configuration comprising parameters and/or a hopping pattern to apply at least one of: a comb offset hopping, a cyclic shift hopping, or a TD-OCC hopping. The UE generates an SRS using one or more of the comb offset hopping, the cyclic shift hopping and the TD-OCC hopping based on the parameters and/or the hopping pattern. The UE transmits, to the network entity, the SRS. The SRS hopping pattern component 140 may be within the wireless baseband processor 926, the application processor 906, or both the wireless baseband processor 926 and the application processor 906. The SRS hopping pattern component 140 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 900 may include a variety of components configured for various functions. In one configuration, the apparatus 900, and in particular the wireless baseband processor 926 and/or the application processor 906, includes means for receiving, from a network entity, an SRS-randomization configuration comprising parameters and/or a hopping pattern to apply at least one of: a comb offset hopping, a cyclic shift hopping, or a TD-OCC hopping. The apparatus 900 includes means for generating an SRS using one or more of the comb offset hopping, the cyclic shift hopping and the TD-OCC hopping based on the parameters and/or the hopping pattern. The apparatus 900 includes means for transmitting, to the network entity, the SRS. The means may be the SRS hopping pattern component 140 of the apparatus 900 configured to perform the functions recited by the means.

FIG. 10 is a diagram 1000 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 1046, which may have on-chip memory 1046′. In some aspects, the CU 110 may further include an additional module of memory 1056 and/or a communications interface 1048, both of which may be coupled to the CU processor 1046. The CU 110 can communicate with the DU 108 through a midhaul link 162, such as an F1 interface between the communications interface 1048 of the CU 110 and a communications interface 1028 of the DU 108.

The DU 108 may include a DU processor 1026, which may have on-chip memory 1026′. In some aspects, the DU 108 may further include an additional module of memory 1036 and/or the communications interface 1028, both of which may be coupled to the DU processor 1026. The DU 108 can communicate with the RU 106 through a fronthaul link 160 between the communications interface 1028 of the DU 108 and a communications interface 1008 of the RU 106.

The RU 106 may include an RU processor 1006, which may have on-chip memory 1006′. In some aspects, the RU 106 may further include an additional module of memory 1016, the communications interface 1008, and one or more transceivers 1030, all of which may be coupled to the RU processor 1006. The RU 106 may further include antennas 1040, which may be coupled to the one or more transceivers 1030, such that the RU 106 can communicate through the one or more transceivers 1030 via the antennas 1040 with the UE 102.

The on-chip memory 1006′, 1026′, 1046′ and the additional modules of memory 1016, 1036, 1056 may each be considered a computer-readable medium/memory. Each computer-readable medium/memory may be non-transitory. Each of the processors 1006, 1026, 1046 is responsible for general processing, including execution of software stored on the computer-readable medium/memory. The software, when executed by the corresponding processor(s) 1006, 1026, 1046 causes the processor(s) 1006, 1026, 1046 to perform the various functions described herein. The computer-readable medium/memory may also be used for storing data that is manipulated by the processor(s) 1006, 1026, 1046 when executing the software. In examples, the component 150 may sit at the one or more network entities 104, such as at the CU 110; both the CU 110 and the DU 108; each of the CU 110, the DU 108, and the RU 106; the DU 108; both the DU 108 and the RU 106; or the RU 106.

As discussed, the SRS configuration component 150 configured to transmit, to a user equipment (UE), an SRS-randomization configuration comprising parameters and/or a hopping pattern to apply at least one of: a comb offset hopping, a cyclic shift hopping, or a TD-OCC hopping. The SRS configuration component 150 is configured to receive, from the UE, the SRS generated using one or more of the comb offset hopping, the cyclic shift hopping and the TD-OCC hopping based on the parameters and/or the hopping pattern. The SRS configuration component 150 may be within one or more processors of one or more of the CU 110, DU 108, and the RU 106. The SRS configuration component 150 may be one or more hardware components specifically configured to carry out the stated processes/algorithm, implemented by one or more processors configured to perform the stated processes/algorithm, stored within a computer-readable medium for implementation by one or more processors, or some combination thereof.

The one or more network entities 104 may include a variety of components configured for various functions. In one configuration, the one or more network entities 104 includes means for transmitting, to a user equipment (UE), an SRS-randomization configuration comprising parameters and/or a hopping pattern to apply at least one of: a comb offset hopping, a cyclic shift hopping, or a TD-OCC hopping. The one or more network entities 104 includes means for receiving, from the UE, the SRS generated using one or more of the comb offset hopping, the cyclic shift hopping and the TD-OCC hopping based on the parameters and/or the hopping pattern. The means may be the SRS configuration component 150 of the one or more network entities 104 configured to perform the functions recited by the means.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a user equipment (UE) emitting sounding reference signals, SRSs, the method including receiving, from a network entity, an SRS-randomization configuration comprising parameters and/or a hopping pattern to apply at least one of: a comb offset hopping, a cyclic shift hopping, or a TD-OCC hopping; generating an SRS using one or more of the comb offset hopping, the cyclic shift hopping and the TD-OCC hopping based on the parameters and/or the hopping pattern; and transmitting, to the network entity, the SRS.

Example 2 may be combined with example 1 and further includes transmitting, to the network entity, a UE capability report indicating a UE's ability to apply the comb offset hopping, the cyclic shift hopping and/or the TD-OCC hopping.

Example 3 may be combined with any of examples 1 or 2 and includes that the UE capability report indicates an SRS type for which the UE is able to apply at least one of the comb offset hopping, the cyclic shift hopping and the TD-OCC hopping.

Example 4 may be combined with any of examples 2 or 3 and includes that the UE capability report indicates at least one of a first maximum number of comb offsets associated with the comb offset hopping, a second maximum number of cyclic shifts associated with the cyclic shift hopping, or a third maximum number of TD-OCCs associated with the TD-OCC hopping.

Example 5 may be combined with any of examples 1 to 4 and further includes receiving, from the network entity, control signaling that triggers the generating of the SRS using the one or more of the comb offset hopping, the cyclic shift hopping and the TD-OCC hopping based on the parameters and/or the hopping pattern, the control signaling indicates resources for the transmitting of the SRSs generated using the one or more of the comb offset hopping, the cyclic shift hopping and the TD-OCC hopping based on the parameters and/or the hopping pattern.

Example 6 may be combined with an example 5 and includes that the control signaling includes two separate control signaling.

Example 7 may be combined with an example 6 and includes that the receiving of the control signaling comprises receiving a radio resource control (RRC) signaling that indicates the resources for the transmitting of the SRSs and a medium access-control element (MAC-CE) or a downlink control information (DCI) that triggers the generating of the SRS.

Example 8 may be combined with any of examples 1 to 7 and includes that the SRS-randomizing configuration indicates candidate resources for the transmitting of the SRS, and the SRS is transmitted on one of the candidate resources.

Example 9 may be combined with any of examples 1 to 8 and includes that a comb offset associated with the comb offset hopping, a cyclic shift associated with the cyclic shift hopping, and a TD-OCC associated with the TD-OCC hopping for an SRS port corresponding to a symbol are each based on at least one of a symbol index of the symbol, a slot index of the symbol, a port index, a cell identifier (ID), or a virtual cell ID.

Example 10 may be combined with any of examples 1 to 8 and includes that a comb offset associated with the comb offset hopping, a cyclic shift associated with the cyclic shift hopping, and a TD-OCC associated with the TD-OCC hopping for an SRS port associated with all symbols for an SRS resource are each based on at least one of a symbol index of a first or a last symbol for the SRS resource, a slot index of a first or a last symbol for the SRS resource, a port index, a cell ID, or a virtual cell ID.

Example 11 may be combined with any of examples 1 to 8 and includes that a comb offset associated with comb offset hopping and a cyclic shift associated with the cyclic shift hopping for an SRS port associated with a group of SRS symbols for an SRS resource are each based on at least one of a symbol index of a first or a last symbol within the group of SRS symbols, a slot index of a first or a last symbol within the group of SRS symbols, a port index, a cell ID, or a virtual cell ID.

Example 12 may be combined with any of examples 1 to 8 and includes that a comb offset associated with the comb offset hopping for all SRS ports in an SRS symbol for an SRS resource is based on at least one of a symbol index of a first or a last symbol within a group of SRS symbols, a slot index of a first or a last symbol within a group of SRS symbols, a common port index, a cell ID, or a virtual cell ID.

Example 13 may be combined with example 12 and further includes that a comb offset associated with the comb offset hopping for all SRS ports in all SRS symbols for an SRS resource is based on at least one of a symbol index of a first or a last symbol for the SRS resource, a slot index of a first or a last symbol for the SRS resource, a port index, a cell ID, or a virtual cell ID.

Example 14 may be combined with any of examples 1 to 8 and includes that a comb offset associated with the comb offset hopping for all SRS ports in an SRS symbol for an SRS resource is based on at least one of a symbol index of a first or a last symbol within a group of SRS symbols, a slot index of a first or a last symbol within a group of SRS symbols, a port index, a cell ID, or a virtual cell ID.

Example 15 is a method wireless communication at a network entity, the method including: transmitting, to a user equipment (UE), an SRS-randomization configuration comprising parameters and/or a hopping pattern to apply at least one of: a comb offset hopping, a cyclic shift hopping, or a TD-OCC hopping; receiving, from the UE, the SRS generated using one or more of the comb offset hopping, the cyclic shift hopping and the TD-OCC hopping based on the parameters and/or the hopping pattern.

Example 16 is an apparatus for wireless communication comprising a wireless communication interface and a processor coupled to the wireless communication interface configured to implement a method as in any of examples 1-15.

1. A method of wireless communication at a user equipment (UE), the method comprising:
receiving, from a network entity, a configuration comprising parameters to apply at least one of:
a comb offset hopping, or
a cyclic shift hopping:
generating a sounding reference signal (SRS) using the at least one of the comb offset hopping or the cyclic shift hopping based on the parameters, a comb offset associated with the comb offset hopping and a cyclic shift associated with the cyclic shift hopping for an SRS port corresponding to a symbol, the comb offset and the cyclic shift each being based on a symbol index, a slot index, and a frame index; and
transmitting, to the network entity, the SRS.

2. The method of claim 1, further comprising:
transmitting, to the network entity, a UE capability report indicating a capability of the UE to apply the at least one of:
the comb offset hopping,
the cyclic shift hopping, or
both the comb offset hopping and the cyclic shift hopping.

3. The method of claim 2, wherein the UE capability report further indicates an SRS type for which the UE is able to apply the at least one of the comb offset hopping or the cyclic shift hopping.

4. The method of claim 2, wherein the UE capability report further indicates at a maximum number of cyclic shifts associated with the cyclic shift hopping.

5. The method of claim 1, further comprising:
receiving, from the network entity, control signaling that triggers the generating the SRS using the at least one of the comb offset hopping or the cyclic shift hopping, wherein the control signaling indicates resources for the transmitting the SRS generated using the at least one of the comb offset hopping or the cyclic shift hopping.

6. The method of claim 5, wherein the control signaling includes two separate control signaling.

7. The method of claim 6, wherein the receiving the control signaling comprises receiving:
a radio resource control (RRC) signaling that indicates the resources for the transmitting the SRS, and
a medium access-control element (MAC-CE) or a downlink control information (DCI) that triggers the generating the SRS.

8. The method of claim 1, wherein the configuration indicates candidate resources for the transmitting the SRS, and the SRS is transmitted on one of the candidate resources.

9. The method of claim 1, wherein the comb offset and the cyclic shift are each further based on at least one of a port index, a cell identifier (ID) or a virtual cell ID.

10. The method of claim 1, wherein the comb offset and the cyclic shift are associated with all symbols for an SRS resource and are each based on at least one of a symbol index of a first or a last symbol for the SRS resource, a slot index of a first or a last symbol for the SRS resource, a port index, a cell identifier (ID), or a virtual cell ID.

11. The method of claim 1, wherein the comb offset is associated with a group of SRS symbols and is based on a first symbol index of a first symbol within the group of SRS symbols.

12. The method of claim 1, wherein the comb offset is for all SRS ports in an SRS symbol for an SRS resource and is based on at least one of a symbol index of a first or a last symbol within a group of SRS symbols, a slot index of a first or a last symbol within the group of SRS symbols, a common port index, a cell identifier (ID), or a virtual cell ID.

13. The method of claim 12, wherein the comb offset is for all SRS ports in all SRS symbols for an SRS resource and is based on at least one of a symbol index of a first or a last symbol for the SRS resource, a slot index of a first or a last symbol for the SRS resource, a port index, a cell identifier (ID), or a virtual cell ID.

14. The method of claim 1, wherein the comb offset is for all SRS ports in an SRS symbol for an SRS resource and is based on at least one of a symbol index of a first or a last symbol within a group of SRS symbols, a slot index of a first or a last symbol within the group of SRS symbols, a port index, a cell identifier (ID), or a virtual cell ID.

15. A method of wireless communication at a network entity, the method comprising:
transmitting, to a user equipment (UE), a configuration comprising parameters to apply at least one of:
a comb offset hopping, or
a cyclic shift hopping; and
receiving, from the UE, a sounding reference signal (SRS) generated using the at least one of the comb offset hopping or the cyclic shift hopping based on the parameters, a comb offset associated with the comb offset hopping and a cyclic shift associated with the cyclic shift hopping for an SRS port corresponding to a symbol, the comb offset and the cyclic shift each being based on a symbol index, a slot index, and a frame index.

16. The method of claim 15, further comprising:
receiving, from the UE, a UE capability report indicating a capability of the UE to apply at least one of:
the comb offset hopping,
the cyclic shift hopping, or
both the comb offset hopping and the cyclic shift hopping.

17. An apparatus for wireless communication comprising:
a wireless communication interface; and
a processor coupled to the wireless communication interface configured to:
receive, from a network entity, a configuration comprising parameters to apply at least one of:
a comb offset hopping, or
a cyclic shift hopping:
generate a sounding reference signal (SRS) using the at least one of the comb offset hopping or the cyclic shift hopping based on the parameters, a comb offset associated with the comb offset hopping and a cyclic shift associated with the cyclic shift hopping for an SRS port corresponding to a symbol, the comb offset and the cyclic shift each being based on a symbol index, a slot index, and a frame index; and
transmit, to the network entity, the SRS.

18. The apparatus of claim 17, wherein the processor is further configured to:
transmit, to the network entity, a UE capability report indicating a capability of a user equipment (UE) to apply the at least one of:
the comb offset hopping,
the cyclic shift hopping, or
both the comb offset hopping and the cyclic shift hopping.

19. The apparatus of claim 18, wherein the UE capability report further indicates:
an SRS type for which the UE is able to apply the at least one of the comb offset hopping or the cyclic shift hopping, or
a maximum number of cyclic shifts associated with the cyclic shift hopping.

20. The apparatus of claim 17, wherein the comb offset is associated with a group of SRS symbols and is based on a first symbol index of a first symbol within the group of SRS symbols.
